(19) United States
(12) Patent Application Publication
(10) Pub. No.: US 2026/0067978 A1
(43) Pub. Date: Mar. 5, 2026

(54) METHOD AND APPARATUS FOR EXPERIENCE MEASUREMENT COLLECTION (QMC) CONFIGURATION

(71) Applicant: BEIJING XIAOMI MOBILE SOFTWARE CO., LTD., Beijing (CN)

(72) Inventor: Yanhua LI, Beijing (CN)

(73) Assignee: BEIJING XIAOMI MOBILE SOFTWARE CO., LTD., Beijing (CN)

(21) Appl. No.: 19/110,856

(22) PCT Filed: Sep. 21, 2022
(86) PCT No.: PCT/CN2022/120356

§ 371 Date: Mar. 12, 2025

(51) Int. Cl. H04W 76/27; H04W 24/08

(52) U.S. Cl. CPC H04W 76/27; H04W 24/08

(57) ABSTRACT

A method for quality of experience measurement collection (QMC) configuration, executed by a first node, includes: sending a first message to a second node, in which the first message comprises QMC-related request information; receiving a second message sent by the second node in response to the first message; and determining, based on the second message, whether to perform the QMC configuration for a user equipment (UE), in which the UE is in at least one of a radio resource control inactive (RRC_INACTIVE) state or a radio resource control idle (RRC_IDLE) state.

### CROSS-REFERENCE TO RELATED APPLICATIONS

This application is a U.S. National Phase of International Application No. PCT/CN2022/120356, filed Sep. 21, 2022, the entire content of which is incorporated herein by reference.

### TECHNICAL FIELD

The present disclosure relates to the field of communications technologies, and in particular to a method, an apparatus, a device and a storage medium for quality of experience measurement collection (QMC) configuration.

### BACKGROUND

During communication process, quality of experience (QoE) refers to a user's service quality experience. In the 3rd generation partnership project (3GPP) network, the QoE can be reflected by some application layer parameters, and QMC is called QoE measurement collection, which is a means for operators to collect the quality of experience QoE parameters of specific services (such as video, voice, etc.) from an application layer of a user equipment (UE) through network configuration. Operators can use QMC to obtain service experiences of users in the network, locate users with poor experience and related problems, and analyze and optimize experiences of the users. In the related art, the base station sends activation or deactivation QoE configuration to the UE only when the UE is in a radio resource control (RRC) connection RRC_CONNECTED state.

### SUMMARY

A first aspect of the present disclosure provides a method for quality of experience measurement collection (QMC) configuration, executed by a first node and including: sending a first message to a second node, wherein the first message includes QMC-related request information; receiving a second message sent by the second node in response to the first message; and determining, based on the second message, whether to perform the QMC configuration for a UE, where the UE is in at least one of a radio resource control inactive (RRC_INACTIVE) state or a radio resource control idle (RRC_IDLE) state.

A second aspect of the present disclosure provides a method for QMC configuration, executed by a second node and including: receiving a first message sent by a first node, where the first message includes QMC-related request information; sending a second message to the first node in response to the first message, where the second message is used to determine whether to perform the QMC configuration for the UE, where the UE is in at least one of an RRC_INACTIVE state or an RRC_IDLE state.

A third aspect of the present disclosure provides a method for QMC configuration, executed by a UE and including: receiving a paging message from a first node, where the paging message includes QMC-related indication information; sending a request message to the first node in response to the paging message, where the request message is determined based on state information of the UE.

A fourth aspect of the present disclosure provides a first node, including a processor; and a memory for storing instructions executable by the processor. The processor is configured to execute the method in the first aspect of the present disclosure.

A fifth aspect of the present disclosure provides a second node, including a processor and a memory for storing instructions executable by the processor. The processor is configured to execute the method in the second aspect of the present disclosure.

A sixth aspect of the present disclosure provides a user equipment (UE) side, including a processor and a memory for storing instructions executable by the processor. The processor is configured to execute the method in the third aspect of the present disclosure.

A seventh aspect of the present disclosure provides a system for QMC configuration, including: a first node in the first aspect and a second node in the second aspect, where the first node is used for sending a first message to a second node, where the first message contains QMC-related request information, and the second node is used for receiving the first message from the first node, and for sending a second message to the first node in response to the first message; where the first node is further used for receiving the second message sent by the second node in response to the first message, and for determining, based on the second message, whether to perform the QMC configuration for the UE, where the UE is in at least of an RRC_INACTIVE state or an RRC_IDLE state.

### BRIEF DESCRIPTION OF THE DRAWINGS

The above and/or additional aspects and advantages of the present disclosure will become apparent and easily understood from the following description of the embodiments in conjunction with the accompanying drawings.

FIG. 1 is a schematic diagram of a flowchart of a method for QMC configuration provided by an embodiment of the present disclosure;

FIG. 2 is a schematic diagram of a flowchart of a method for QMC configuration provided by another embodiment of the present disclosure;

FIG. 3 is a schematic diagram of a flowchart of a method for QMC configuration provided by yet another embodiment of the present disclosure;

FIG. 4 is a schematic diagram of a flowchart of a method for QMC configuration provided by yet another embodiment of the present disclosure;

FIG. 5 is a schematic diagram of a flowchart of a method for QMC configuration provided by yet another embodiment of the present disclosure;

FIG. 6 is a schematic diagram of a flowchart of a method for QMC configuration provided by yet another embodiment of the present disclosure;

FIG. 7 is a schematic diagram of a flowchart of a method for QMC configuration provided by yet another embodiment of the present disclosure;

FIG. 8 is a schematic diagram of a flowchart of a method for QMC configuration provided by yet another embodiment of the present disclosure;

FIG. 9 is a schematic diagram of a flowchart of a method for QMC configuration provided by yet another embodiment of the present disclosure;

FIG. 10 is a schematic diagram of a flowchart of a method for QMC configuration provided by yet another embodiment of the present disclosure;

FIG. 11 is a schematic diagram of a flowchart of a method for QMC configuration provided by yet another embodiment of the present disclosure;

FIG. 12 is a schematic diagram of a flowchart of a method for QMC configuration provided by yet another embodiment of the present disclosure;

FIG. 13 is a schematic diagram of a flowchart of a method for QMC configuration provided by yet another embodiment of the present disclosure;

FIG. 14 is a schematic diagram of a flowchart of a method for QMC configuration provided by another embodiment of the present disclosure;

FIG. 15 is a schematic diagram of a flowchart of a method for QMC configuration provided by another embodiment of the present disclosure;

FIG. 16 is a schematic diagram of a structure of an apparatus for QMC configuration provided by an embodiment of the present disclosure;

FIG. 17 is a schematic diagram of a structure of an apparatus for QMC configuration provided by another embodiment of the present disclosure;

FIG. 18 is a schematic diagram of a structure of an apparatus for QMC configuration provided by another embodiment of the present disclosure;

FIG. 19 is a schematic diagram of a structure of a system for QMC configuration provided by an embodiment of the present disclosure;

FIG. 20 is a schematic diagram of an interaction of a method for QMC configuration provided by an embodiment of the present disclosure;

FIG. 21 is a schematic diagram of an interaction of a method for QMC configuration provided by another embodiment of the present disclosure;

FIG. 22 is a block diagram of a UE provided by an embodiment of the present disclosure;

FIG. 23 is a block diagram of a base station provided by an embodiment of the present disclosure.

### DETAILED DESCRIPTION

Exemplary embodiments will be described in detail herein, examples of which are shown in the accompanying drawings. When the following description refers to the drawings, unless otherwise indicated, the same numbers in different drawings represent the same or similar elements. The implementations described in the following exemplary embodiments do not represent all implementations consistent with the embodiments of the present disclosure. Instead, they are merely examples of devices and methods consistent with some aspects of the embodiments of the present disclosure as detailed in the appended claims.

The terms used in the embodiments of the present disclosure are only for the purpose of describing specific embodiments and are not intended to limit the embodiments of the present disclosure. The singular forms of “a”, “an” and “the” used in the embodiments and the appended claims of the present disclosure are also intended to include plural forms unless the context clearly indicates other meanings. It should also be understood that the term “and/or” used herein refers to and includes any or all possible combinations of one or more associated listed items.

It should be understood that although the terms first, second, third, etc. may be used to describe various information in the embodiments of the present disclosure, these information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the words “if” and “in a case” as used herein may be interpreted as “while” or “when”or “in response to”.

The network elements or network functions involved in the embodiments of the present disclosure may be implemented by independent hardware devices or by software in the hardware devices, and this is not limited in the embodiments of the present disclosure.

In an embodiment of the present disclosure, in the new radio (NR) QoE of R17, since supported services include video streaming services, voice services and virtual reality VR (virtual reality), QoE measurement collection configuration and QoE result reporting are only performed in the Radio Resource Control (RRC) connection RRC_CONNECTED state.

QMC can be configured directly from the operation administration and maintenance (OAM) system, i.e., management-based QoE measurement, or signaled from OAM through a core network, i.e., signaling-based QoE measurement.

For signaling-based QoE measurement, the OAM initiates QoE measurement activation for a specific UE through the core network, and the NG-radio access network (RAN) node receives one or more QoE measurement configurations through UE-related signaling. The signaling-based QoE measurement configuration includes an application layer measurement configuration list and corresponding information for QoE measurement collection, such as a QoE reference, a service type, a MCE IP address, a slice range, an area range, a minimization drive test (MDT) alignment information, and an indication of visible QoE metrics of available RANs. The NG-RAN node can forward the corresponding QoE measurement configuration to the UE via a downlink RRC message.

For management-based QoE measurement activation, the OAM can send one or more QoE measurement configurations to the NG-RAN node. The management-based QoE measurement configuration also includes an application layer measurement configuration list and corresponding information for QoE measurement collection. The NG-RAN node can select UE(s), an area scope and a slice scope that meet the QoE measurement capability to perform QoE measurement configuration on the UE.

In an embodiment of the present disclosure, in R18 NR QoE enhancement, it is decided to support a multicast-broadcast service (MBS), and UE can perform the MBS in RRC_IDLE and RRC_INACTIVE states, but QoE configuration (including activation and deactivation of QoE measurement) for UE in RRC_IDLE and RRC_INACTIVE states is an urgent problem to be solved. In the related art, the base station only sends the activation or deactivation of QoE configuration to the UE when the UE is in the RRC_CONNECTED state. However, this solution is not suitable for management-based QoE measurement (i.e., QoE collection for a specific area). If the base station receives the management-based QoE configuration, the base station can only select the UE in the RRC_CONNECTED state under its service to perform QoE configuration, but cannot select the UE in the RRC_INACTIVE and RRC_IDLE states, which limits the scope of QoE collection and the amount of data collected, making the QoE information acquisition inaccurate.

A method, an apparatus, a device, and a storage medium for QMC configuration provided by an embodiment of the present disclosure are described in detail below with reference to the accompanying drawings.

FIG. 1 is a flowchart of a method for QMC configuration provided by an embodiment of the present disclosure. The method is executed by a first node. As shown in FIG. 1, the method may include the following steps.
Step 101: sending a first message to a second node, where the first message includes QMC-related request information.
Step 102: receiving a second message sent by the second node in response to the first message.
Step 103: determining, based on the second message, whether to perform the QMC configuration for a UE, where the UE is in a radio resource control inactive (RRC_INACTIVE) state and/or a radio resource control idle (RRC_IDLE) state.

It should be noted that, in an embodiment of the present disclosure, the UE may be a device that provides voice and/or data connectivity to the user. The UE may communicate with one or more core networks via a RAN (radio access network). The UE may be an IoT device, such as a sensor device, a mobile phone (or a “cellular” phone), and a computer with an IoT device. For example, it may be a fixed, portable, pocket-sized, handheld, computer-built-in, or vehicle-mounted device, for example, a subscriber station (STA), a subscriber unit, a subscriber station, a mobile station, a mobile, a remote station, an access point, a remote terminal, an access terminal, a user terminal, or a user agent. Optionally, the UE may be a device of an unmanned aerial vehicle. Optionally, the UE may be a vehicle-mounted device, for example, it may be a driving computer with wireless communication function, or a wireless device connected to an external driving computer. Optionally, the UE may also be a roadside device, for example, a street lamp, a traffic light or other roadside device with a wireless communication function.

In an embodiment of the present disclosure, QMC and QoE are used to indicate related information. For example, QMC may be a QoE measurement collection process, and the QMC is used to measure, collect and/or process QoE. In an embodiment of the present disclosure, QMC and QoE may have the same meaning.

In an embodiment of the present disclosure, an expression “first” in the “first message” is only used to distinguish the first message from other messages and does not specifically refer to a specific message. The first message refers to a message sent by the first node to the second node and includes QMC-related request information.

In an embodiment of the present disclosure, the second message refers to the message that the second node feeds back to the first node in response to the first message. The expression “second” in the “second message” is only used to distinguish the second message from other messages and does not specifically refer to a specific message.

In an embodiment of the present disclosure, the QMC-related request information includes information indicating a QMC request, and receiving the second message sent by the second node in response to the first message includes:
receiving the second message sent by the second node based on the information indicating the QMC request, where the second message includes capability information related to application layer measurement of the UE;
where determining, based on the second message, whether to perform the QMC configuration for the UE includes:
determining, based on the capability information related to the application layer measurement of the UE, whether to perform the QMC configuration for the UE.

In an embodiment of the present disclosure, the QMC-related request information includes a requested service type, and receiving the second message sent by the second node in response to the first message includes:
receiving the second message sent by the second node based on capability of the UE and the requested service type, where the second message includes QMC support indication information of the UE;
where determining, based on the second message, whether to perform the QMC configuration for the UE includes:
determining, based on the QMC support indication information of the UE, whether to perform the QMC configuration for the UE.

Illustratively, in an embodiment of the present disclosure, the QMC-related request information further includes at least one of the following:
information indicating a QMC request; or
a requested communication type.

Illustratively, in an embodiment of the present disclosure, the QMC-related request information includes a QMC configuration, and receiving the second message sent by the second node in response to the first message includes:
receiving the second message sent by the second node based on capability of the UE and the QMC configuration, where the second message includes an encapsulated RRC release message, and the encapsulated RRC release message contains the QMC configuration.

The method further includes:
forwarding an RRC release message to the UE.

Further, in an embodiment of the present disclosure, when the second node determines not to perform context relocation, the first node may send the QMC configuration to the second node. The second node may encapsulate the QMC configuration into the RRC release message. The second node may encapsulate the RRC release message and send the encapsulated RRC release message to the first node.

Further, in an embodiment of the present disclosure, when the first node determines to perform the QMC configuration for the UE based on the second message, the first node forwards the RRC release message to the UE.

Furthermore, in an embodiment of the present disclosure, the second message further includes an indication message that determines to perform the QMC configuration.

Furthermore, in an embodiment of the present disclosure, it is determined to perform the QMC configuration for the UE according to the indication message that determines to perform the QMC configuration.

Optionally, in an embodiment of the present disclosure, the indication message that determines to perform the QMC configuration may be one or more QoE references (QoE References).

In an embodiment of the present disclosure, the QoE reference is an identifier of the QMC.

In an embodiment of the present disclosure, determining whether to perform the QMC configuration for the UE includes:
sending a third message to the second node in a case of determining to perform the QMC configuration for the UE, where the third message includes the QMC configuration;
receiving a fourth message sent by the second node, where the fourth message includes an encapsulated RRC release message, and the RRC release message includes the QMC configuration; and
sending an RRC release message to the UE.

Illustratively, in an embodiment of the present disclosure, the second node may encrypt the QMC configuration and encapsulate the encrypted QMC configuration in an RRC release message, which may improve the security of the QMC configuration.

In an embodiment of the present disclosure, determining whether to perform QMC configuration for the UE includes:
sending the QMC configuration to the UE in a case of determining to perform the QMC configuration for the UE; and
sending a third message to the second node, where the third message includes a configured QMC.

In an embodiment of the present disclosure, a configured QMC may include at least one of the following information:
a QoE reference;
a service type;
a communication type;
effective time of the configuration; or
a QMC type.

The QMC type may be, for example, a signaling QMC-based type or a management QMC-based type.

In an embodiment of the present disclosure, sending the first message to the second node includes:
receiving a request message sent by the UE based on state information of the UE; and
sending the first message to the second node based on the request message.

Illustratively, in an embodiment of the present disclosure, the request message includes at least one of the following:
a Radio Resource Control (RRC) resume request (RRC Resume Request) message, where a resume cause in the RRC Resume Request message is QMC-related information; or
an RRC setup request (RRC Setup Request) message, where a cause in the RRC Setup Request message is the QMC-related information.

Illustratively, in an embodiment of the present disclosure, before receiving the request message sent by the UE based on the state information of the UE, the method further includes:
sending a paging message to the UE, where the paging message includes QMC-related indication information.

Illustratively, in an embodiment of the present disclosure, the first node may send the paging message to at least one UE, where the paging message includes the QMC-related indication information. Optionally, the paging message may include the service type and/or communication type corresponding to the collected QoE.

Further, in an embodiment of the present disclosure, the service type includes but is not limited to video service, a voice service, a MBS, a broadcast service, a multicast service, etc.

Furthermore, in an embodiment of the present disclosure, the communication type includes but is not limited to a broadcast communication type, a multicast communication type, and the like.

Illustratively, in an embodiment of the present disclosure, when a UE receives the paging message sent by the first node, if the UE determines that the paging message includes QMC-related indication information or QoE-related indication information, and if the UE has one or more sessions in progress, the UE may send an RRC Resume Request message to the first node, where the RRC Resume Request message includes a resume cause, and the resume cause may be information related to QoE, such as a QoE or QMC indication.

Illustratively, in an embodiment of the present disclosure, a first node receives the RRC Resume Request message sent by a UE. If the UE determines that the resume cause included in the RRC Resume Request message is related to QoE collection (for example, the resume cause is information related to QoE), the first node may send a first message to a second node, where the second node may be a base station where the context of the UE is located, and the first message may be a retrieve UE context request message or another Xn application protocol (XnAP) message, and the first message includes information indicating the QMC request, such as QoE support request information. The first node may be a base station, and the second node may also be a base station.

Further, in an embodiment of the present disclosure, a second node receives the first message sent by a first node. If the second node determines that the first message includes information indicating the QMC request, the second node may decide whether to perform context relocation on the UE. If the second node decides to perform context relocation, the second node sends a retrieve UE context response message to the first node. If the second node decides not to perform context relocation, the second node sends a second message to the first node. The second message may be a partial UE context transfer message of a UE, a retrieve UE context failure message, a UE QMC context transfer message, or another XnAP message. The second message may include capability information related to application layer measurement of the UE, such as whether to support QoE measurement and reporting of MBS, whether to support QoE collection and reporting that are visible to a RAN, etc.

Illustratively, in an embodiment of the present disclosure, the first node receives the second message. If the second message includes capability information related to application layer measurement, the first node decides whether to configure application layer measurement (i.e., QoE measurement or QMC measurement) for the UE based on the capability information related to application layer measurement. If the first node determines to configure application layer measurement for the UE, the first node may send an RRC release message to the UE, and the RRC release message includes application layer measurement configuration information. The UE receives the application layer measurement configuration information, and performs application layer measurement and reporting based on the application layer measurement configuration information.

Further, in an embodiment of the present disclosure, the first node receives the RRC Resume Request message sent by the UE. If the UE determines that the resume cause included in the RRC Resume Request message is related to QoE collection (for example, the resume reason is information related to QoE), the first node may send a first message to the second node, where the second node may be the base station where the UE context is located, and the first message may be a Retrieve UE Context Request message or another XnAP message, and the first message includes the requested service type. The first request may also include at least one of information indicating the QMC request and a requested communication type. The information indicating a QMC request may be QoE support request information, etc., and the service type includes but is not limited to a video service, a voice service, a MBS, a broadcast service, a multicast service, etc.; the communication type includes but is not limited to a broadcast communication type, a multicast communication type, etc.

Further, in an embodiment of the present disclosure, the second node receives a first message sent by the first node, and if the second node determines that the first message includes the requested service type, the second node determines whether the UE supports the requested QMC configuration according to the requested service type and the capability information of the UE. The second node sends a second message to the first node, and the second message may be a Partial UE Context Transfer message, a Retrieve UE Context Failure message, a UE QMC Context Transfer message or another XnAP message, and the second message may include QMC support indication information, and the QMC support indication information is obtained by the second node according to the capability of the UE and the requested service type, and the QMC support request information can be used to indicate whether the UE supports application layer measurement of a certain service type and/or communication type.

Further, in an embodiment of the present disclosure, the first node receives a second message sent by the second node. If the second message includes QMC support indication information, the first node considers the information and decides whether to configure application layer measurement (i.e., QoE measurement or QMC measurement) for the UE. If the first node determines to configure application layer measurement for the UE, the first node may send an RRC release message to the UE, and the RRC release message includes application layer measurement configuration information. The UE receives the application layer measurement configuration information, and performs application layer measurement and reporting according to the application layer measurement configuration information.

Illustratively, in an embodiment of the present disclosure, when a UE receives a paging message sent by a first node, if the UE determines that the paging message includes QMC-related indication information or QoE-related indication information, if the UE is in an idle state, the UE may send an RRC Setup Request message to the first node, and the RRC Setup Request message includes a cause, and the cause may be information related to QoE, such as a QoE or QMC indication.

Further, in an embodiment of the present disclosure, the first node receives the RRC Setup Request message sent by the UE. If the UE determines that the cause included in the RRC Setup Request message is related to QoE collection (for example, the resume cause is information related to QoE), the first node may send a first message to the second node, where the second node may be a core network node, the Initial UE Message message, the Retrieve UE Information message, the UE context Resume Request message or other NGAP message, the first message includes information indicating the QMC request, such as QoE support request information. The first node may be a base station, and the second node may be a core network node.

Further, in an embodiment of the present disclosure, the second node receives a first message sent by the first node, and if the second node determines that the first message includes information indicating the QMC request, the second node may send a second message to the first node, and the second message may be a UE Information Transfer message, a UE Context Resume Complete message, or other Next Generation Application Protocol (NGAP) message, and the second message may include capability information related to application layer measurement of the UE, such as whether QoE measurement and reporting of MBS is supported, whether QoE collection and reporting that are visible to the RAN are supported, etc.

Further, in an embodiment of the present disclosure, the first node receives the second message, and if the second message includes capability information related to application layer measurement, the first node determines whether to configure application layer measurement (i.e., QoE measurement or QMC measurement) for the UE based on the capability information related to application layer measurement. If the first node determines to configure application layer measurement for the UE, the first node may send an RRC release message, the RRC release message includes application layer measurement configuration information. The UE receives the application layer measurement configuration information, and performs application layer measurement and reporting according to the application layer measurement configuration information.

Illustratively, in an embodiment of the present disclosure, a first node receives the RRC Setup Request message sent by a UE. If the UE determines that the cause included in the RRC Setup Request message is related to QoE collection (for example, the resume cause is information related to QoE), the first node may send a first message to a second node, where the second node may be a core network node, and the initial UE message (Initial UE Message), the retrieve UE information (Retrieve UE Information) message, the UE context resume request (UE context Request) message or other NGAP message, and the first message includes the requested service type. The first node may be a base station, and the second node may be a core network node.

Further, in an embodiment of the present disclosure, the second node receives a first message sent by the first node, and if the second node determines that the first message includes the requested service type, the second node determines whether the UE supports the requested QMC configuration based on the requested service type and the capability information of the UE. The second node sends a second message to the first node, and the second message may be a UE information transfer (UE Information Transfer) message, a UE context resume completion (UE context Resume Complete) message, or other Next Generation Application Protocol (NGAP) message, and the second message may include QMC support indication information, and the QMC support indication information is obtained by the second node according to the capability of the UE and the requested service type, and the QMC support request information can be used to indicate whether the UE supports application layer measurement of a certain service type and/or communication type.

Further, in an embodiment of the present disclosure, the first node receives a second message sent by the second node. If the second message includes QMC support indication information, the first node considers the information and decides whether to configure application layer measurement (i.e., QoE measurement or QMC measurement) for the UE. If the first node determines to configure application layer measurement for the UE, the first node may send a RRC release message to the UE, and the RRC release message includes application layer measurement configuration information. The UE receives the application layer measurement configuration information, and performs application layer measurement and reporting based on the application layer measurement configuration information.

Illustratively, in an embodiment of the present disclosure,
the first node and the second node are both base stations;
or
the first node is a base station and the second node is a core network node.

In summary, in the embodiment of the present disclosure, the first node sends a first message to the second node, where the first message includes QMC-related request information, the first node receives a second message sent by the second node in response to the first message, and determines whether to perform QMC configuration for the UE based on the second message, where the UE is in a radio resource control inactive (RRC_INACTIVE) state and/or a radio resource control idle (RRC_IDLE) state. In the embodiment of the present disclosure, a QMC configuration mechanism can be provided when the UE is in an RRC_INACTIVE state and/or an RRC_IDLE state, thus avoiding the situation where QMC configuration cannot be performed for the UE in the RRC_INACTIVE state and/or the RRC_IDLE state, which can improve the accuracy of QMC information acquisition and improve the convenience of optimizing services in RRC_INACTIVE and RRC_IDLE states. The present disclosure provides a processing method for a “QMC configuration” situation to provide a QMC configuration mechanism when the UE is in the RRC_INACTIVE state and/or the RRC_IDLE state, thus improving the accuracy of QMC information acquisition, improving the convenience of optimizing services in the RRC_INACTIVE and RRC_IDLE states, and reducing signaling overhead to save power for the UE.

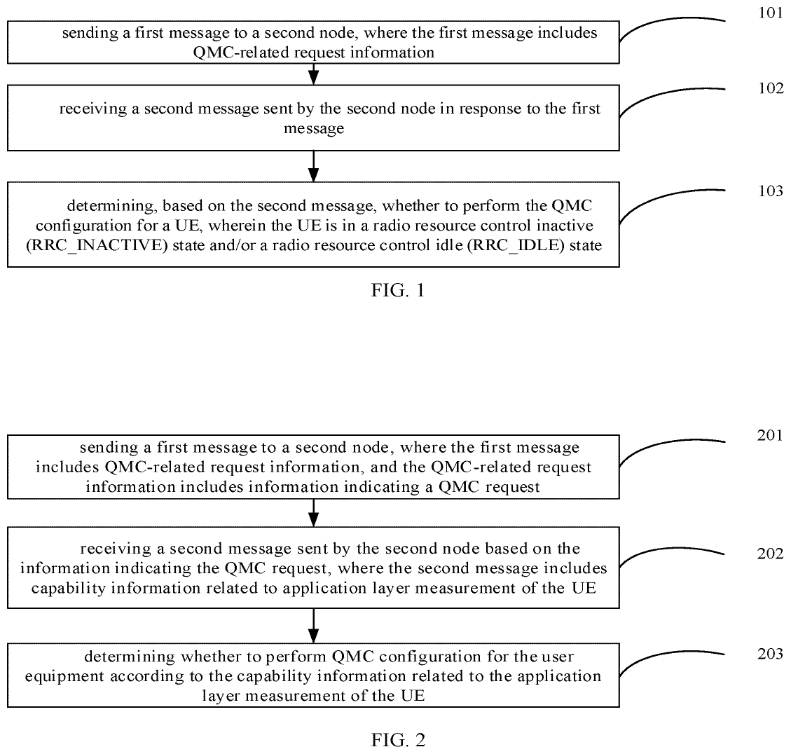

FIG. 2 is a flowchart of a method for QMC configuration provided by an embodiment of the present disclosure. The method is executed by a first node. As shown in FIG. 2, the method may include the following steps.
Step 201: sending a first message to a second node, where the first message includes QMC-related request information, and the QMC-related request information includes information indicating a QMC request.
Step 202: receiving a second message sent by the second node based on the information indicating the QMC request, where the second message includes capability information related to application layer measurement of the UE.
Step 203: determining whether to perform QMC configuration for the UE according to the capability information related to the application layer measurement of the UE.

In an embodiment of the present disclosure, the QMC-related request information includes the information indicating the QMC request.

In an embodiment of the present disclosure,
the first node and the second node are both base stations;
or
the first node is a base station and the second node is a core network node.

Illustratively, in an embodiment of the present disclosure, a first node receives the RRC Resume Request message sent by a UE. If the UE determines that the resume cause included in the RRC Resume Request message is related to QoE collection (for example, the resume cause is QoE-related information), the first node may send a first message to a second node, where the second node may be a base station where the UE context is located, and the first message may be a retrieve UE context request (Retrieve UE Context Request) message or another XnAP message, and the first message includes information indicating the QMC request, such as QoE support request information. The first node may be a base station, and the second node may also be a base station. Further, in an embodiment of the present disclosure, a second node receives the first message sent by a first node. If the second node determines that the first message includes information indicating the QMC request, the second node may decide whether to perform context relocation on the UE. If the second node decides to perform context relocation, the second node sends a Retrieve UE Context Response message to the first node. If the second node decides not to perform context relocation, the second node sends a second message to the first node. The second message may be a partial UE context transfer (Partial UE Context Transfer) message, a Retrieve UE Context Failure message, a UE QMC Context Transfer message, or another XnAP message of the UE. The second message may include capability information related to application layer measurement of the UE, such as whether to support QoE measurement and reporting of MBS, whether to support QoE collection and reporting that are visible to the RAN, etc.

Illustratively, in an embodiment of the present disclosure, the first node receives the second message. If the second message includes capability information related to application layer measurement, the first node decides whether to configure application layer measurement (i.e., QoE measurement or QMC measurement) for the UE based on the capability information related to application layer measurement. If the first node determines to configure application layer measurement for the UE, the first node may send a RRC release message to the UE, and the RRC release message includes application layer measurement configuration information. The UE receives the application layer measurement configuration information, and performs application layer measurement and reporting based on the application layer measurement configuration information.

Further, in an embodiment of the present disclosure, the first node receives the RRC Setup Request message sent by the UE, and if the UE determines that the cause included in the RRC Setup Request message is related to QoE collection (for example, the resume cause is information related to QoE), the first node may send a first message to the second node, where the first node may be a base station and the second node may be a core network node. The initial UE message (Initial UE Message), the retrieval UE information (Retrieve UE Information) message, the UE context resume request (UE Context Resume Request) message or other NGAP message, the first message includes information indicating the QMC request, such as QoE support request information.

Further, in an embodiment of the present disclosure, the second node receives a first message sent by the first node, and if the second node determines that the first message includes information indicating the QMC request, the second node may send a second message to the first node, and the second message may be a UE information transfer (UE Information Transfer) message, a UE context resume complete (UE Context Recovery Complete) message, or other next generation application protocol (Next Generation Application Protocol, NGAP) message, and the second message may include capability information related to application layer measurement of the UE, such as whether QoE measurement and reporting of MBS is supported, whether QoE collection and reporting that are visible to RAN are supported, etc.

Illustratively, in an embodiment of the present disclosure, the first node receives the second message. If the second message includes capability information related to application layer measurement, the first node determines whether to configure application layer measurement (i.e., QoE measurement or QMC measurement) for the UE based on the capability information related to application layer measurement. If the first node determines to configure application layer measurement for the UE, the first node may send a RRC release message to the UE, and the RRC release message includes application layer measurement configuration information. The UE receives the application layer measurement configuration information, and performs application layer measurement and reporting based on the application layer measurement configuration information.

In summary, in the embodiment of the present disclosure, the first node sends a first message to the second node, where the first message includes QMC-related request information, and the QMC-related request information includes information indicating the QMC request; the first node receives the second message sent by the second node based on the information indicating the QMC request, where the second message includes capability information related to the application layer measurement of the UE; and determines whether to perform QMC configuration for the UE according to the capability information related to the application layer measurement of the UE. In the embodiment of the present disclosure, a QMC configuration mechanism can be provided when the UE is in the RRC_INACTIVE state and/or the RRC_IDLE state, thus avoiding the situation where QMC configuration cannot be performed for the UE in the RRC_INACTIVE state and/or the RRC_IDLE state, which can improve the accuracy of QMC information acquisition and improve the convenience of optimizing services in the RRC_INACTIVE and RRC_IDLE states. The embodiment of the present disclosure specifically discloses a solution in which the QMC-related request information includes information indicating the QMC request. The present disclosure provides a processing method for a “QMC configuration” situation to provide a QMC configuration mechanism when the UE is in the RRC_INACTIVE state and/or the RRC_IDLE state, thus improving the accuracy of QMC information acquisition, improving the convenience of optimizing services in the RRC_INACTIVE and RRC_IDLE modes, and reducing signaling overhead to save power for the UE.

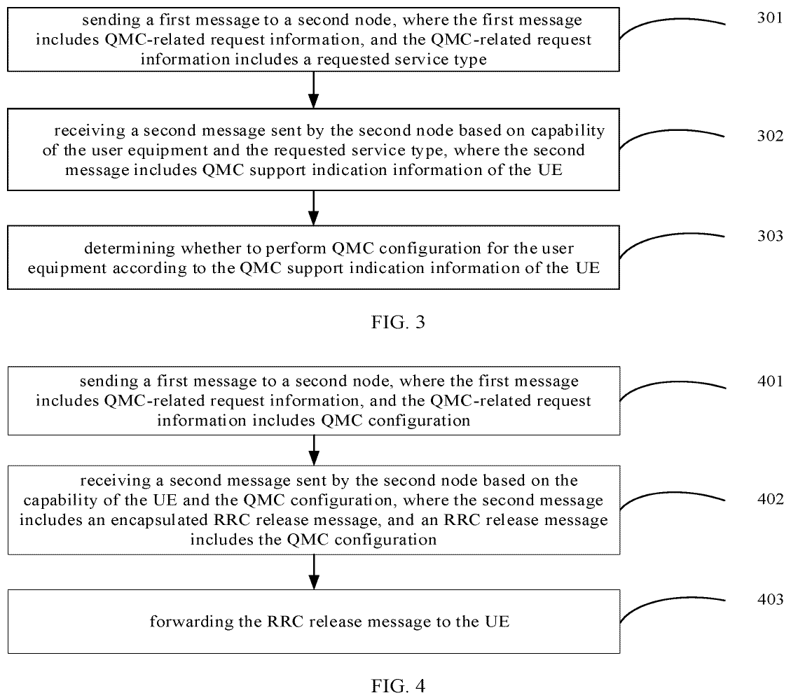

FIG. 3 is a flowchart of a method for QMC configuration provided by an embodiment of the present disclosure. The method is executed by a first node. As shown in FIG. 3, the method may include the following steps.
Step 301: sending a first message to a second node, where the first message includes QMC-related request information, and the QMC-related request information includes a requested service type.
Step 302: receiving a second message sent by the second node based on capability of the UE and the requested service type, where the second message includes QMC support indication information of the UE.
Step 303: determining whether to perform QMC configuration for the UE according to the QMC support indication information of the UE.

In an embodiment of the present disclosure, the QMC-related request information includes the requested service type.

In an embodiment of the present disclosure, the QMC-related request information further includes at least one of the following:
information indicating a QMC request; or
a requested communication type.

Further, in an embodiment of the present disclosure, the first node receives the RRC Resume Request message sent by the UE. If the UE determines that the resume cause included in the RRC Resume Request message is related to QoE collection (for example, the resume reason is information related to QoE), the first node may send a first message to the second node, where the second node may be the base station where the UE context is located, and the first message may be a retrieve UE context request (Retrieve UE Context Request) message or another XnAP message, and the first message includes the requested service type. The first request may also include at least one of information indicating a QMC request and a requested communication type. The information indicating a QMC request may be QoE support request information, etc., and the service type includes but is not limited to a video service, a voice service, a MBS, a broadcast service, a multicast service, etc.; the communication type includes but is not limited to a broadcast communication type, a multicast communication type, etc.

Further, in an embodiment of the present disclosure, the second node receives a first message sent by the first node, and if the second node determines that the first message includes the requested service type, the second node determines whether the UE supports the requested QMC configuration based on the requested service type and the capability information of the UE. The second node sends a second message to the first node, and the second message may be a Partial UE Context Transfer message, a Return UE Context Failure message, a UE QMC Context Transfer message or another XnAP message, and the second message may include QMC support indication information, and the QMC support indication information is obtained by the second node according to the capability of the UE and the requested service type, and the QMC support request information can be used to indicate whether the UE supports application layer measurement of a certain service type and/or communication type.

Further, in an embodiment of the present disclosure, the first node receives a second message sent by the second node. If the second message includes QMC support indication information, the first node considers the information and decides whether to configure application layer measurement (i.e., QoE measurement or QMC measurement) for the UE. If the first node determines to configure application layer measurement for the UE, the first node may send a RRC release message to the UE, and the RRC release message includes application layer measurement configuration information. The UE receives the application layer measurement configuration information, and performs application layer measurement and reporting according to the application layer measurement configuration information.

Illustratively, in an embodiment of the present disclosure, a first node receives the RRC Setup Request message sent by a UE. If the UE determines that the cause included in the RRC Setup Request message is related to QoE collection (for example, the resume cause is information related to QoE), the first node may send a first message to a second node, where the second node may be a core network node, and the initial UE message (Initial UE Message), the retrieve UE information (Retrieve UE Information) message, a UE context resume request (UE context Request) message or other NGAP message, the first message includes the requested service type. The first node may be a base station, and the second node may be a core network node.

Further, in an embodiment of the present disclosure, the second node receives a first message sent by the first node, and if the second node determines that the first message includes the requested service type, the second node determines whether the UE supports the requested QMC configuration according to the requested service type and the capability information of the UE. The second node sends a second message to the first node, and the second message may be a UE information transfer (UE Information Transfer) message, a UE context resume complete (UE context Report Complete) message, or other next generation application protocol (Next Generation Application Protocol, NGAP) message, and the second message may include QMC support indication information, and the QMC support indication information is obtained by the second node according to the capability of the UE and the requested service type, and the QMC support request information can be used to indicate whether the UE supports application layer measurement of a certain service type and/or communication type.

Further, in an embodiment of the present disclosure, the first node receives a second message sent by the second node. If the second message includes QMC support indication information, the first node determines whether to configure application layer measurement (i.e., QoE measurement or QMC measurement) for the UE based on the information. If the first node determines to configure application layer measurement for the UE, the first node may send an RRC release message to the UE, and the RRC release message includes application layer measurement configuration information. The UE receives the application layer measurement configuration information, and performs application layer measurement and reporting based on the application layer measurement configuration information.

In summary, in the embodiment of the present disclosure, the first node sends a first message to the second node, where the first message includes QMC-related request information, and the QMC-related request information includes the requested service type; the first node receives a second message sent by the second node according to the capabilities of the UE and the requested service type, where the second message includes QMC support indication information of the UE; and determines whether to perform the QMC configuration for the UE according to the QMC support indication information of the UE. In the embodiment of the present disclosure, a QMC configuration mechanism can be provided when the UE is in the RRC_INACTIVE state and/or the RRC_IDLE state, so as to avoid the situation where the QMC configuration cannot be performed for the UE in the RRC_INACTIVE state and/or the RRC_IDLE state, and the accuracy of QMC information acquisition can be improved, and the convenience of optimizing services in the RRC_INACTIVE and RRC_IDLE states can be improved. The embodiment of the present disclosure specifically discloses a solution in which the QMC-related request information includes the requested service type. The present disclosure provides a processing method for a “QMC configuration” situation to provide a QMC configuration mechanism when the UE is in the RRC_INACTIVE state and/or the RRC_IDLE state, thus improving the accuracy of QMC information acquisition, improving the convenience of optimizing services in the RRC_INACTIVE and RRC_IDLE states, and reducing signaling overhead to save power for the UE.

FIG. 4 is a flowchart of a method for QMC configuration provided by an embodiment of the present disclosure. The method is executed by a first node. As shown in FIG. 4, the method may include the following steps.
Step 401: sending a first message to a second node, where the first message includes QMC-related request information, and the QMC-related request information includes QMC configuration.
Step 402: receiving a second message sent by the second node based on the capability of the UE and the QMC configuration, where the second message includes an encapsulated RRC release message, and the RRC release message includes the QMC configuration.
Step 403: forwarding the RRC release message to the UE.

In an embodiment of the present disclosure, the second message is generated according to whether the second node determines to perform QMC configuration for the UE, where the second message may include an RRC release message, and if the second node determines to perform QMC configuration for the UE, the RRC release message includes the QMC configuration. Optionally, in an embodiment of the present disclosure, the second message may also include an indication of determining to perform QMC configuration, which is used to indicate that the first node determines whether the second node determines to perform QMC configuration for the UE.

Further, in an embodiment of the present disclosure, when the second node determines not to perform context relocation, the first node may send the QMC configuration to the second node. The second node may encapsulate the QMC configuration into an RRC release message. The second node may encapsulate the RRC release message and send the encapsulated RRC release message to the first node.

Further, in an embodiment of the present disclosure, when the second node determines to perform context relocation, the second node may relocate the UE context to the first node, and the first node may encapsulate the QMC configuration into an RRC release message. The first node may send the encapsulated RRC release message to the UE.

Illustratively, in an embodiment of the present disclosure, that the first node determines, based on the second message, to perform QMC configuration for the UE, is for example that the first node sends a received RR C release message to the UE.

In summary, in the embodiment of the present disclosure, a first message is sent to a second node, where the first message includes QMC-related request information, and the QMC-related request information includes QMC configuration; a second message sent by the second node based on the capability of the UE and QMC configuration is received, where the second message includes an encapsulated RRC release message, and the RRC release message includes QMC configuration; according to the second message, it is determined to perform QMC configuration on the UE, and the RRC release message is forwarded to the UE. In the embodiment of the present disclosure, a QMC configuration mechanism can be provided when the UE is in the RRC_INACTIVE state and/or the RRC_IDLE state, thus avoiding the situation where QMC configuration cannot be performed for the UE in the RRC_INACTIVE state and/or the RRC_IDLE state, which can improve the accuracy of QMC information acquisition and improve the convenience of optimizing services in the RRC_INACTIVE and RRC_IDLE states. The embodiment of the present disclosure specifically discloses a solution in which the QMC-related request information includes QMC configuration. The present disclosure provides a processing method for a “QMC configuration” situation to provide a QMC configuration mechanism when the UE is in the RRC_INACTIVE state and/or the RRC_IDLE state, thus improving the accuracy of QMC information acquisition, improving the convenience of optimizing services in the RRC_INACTIVE and RRC_IDLE states, and reducing signaling overhead to save power for the UE.

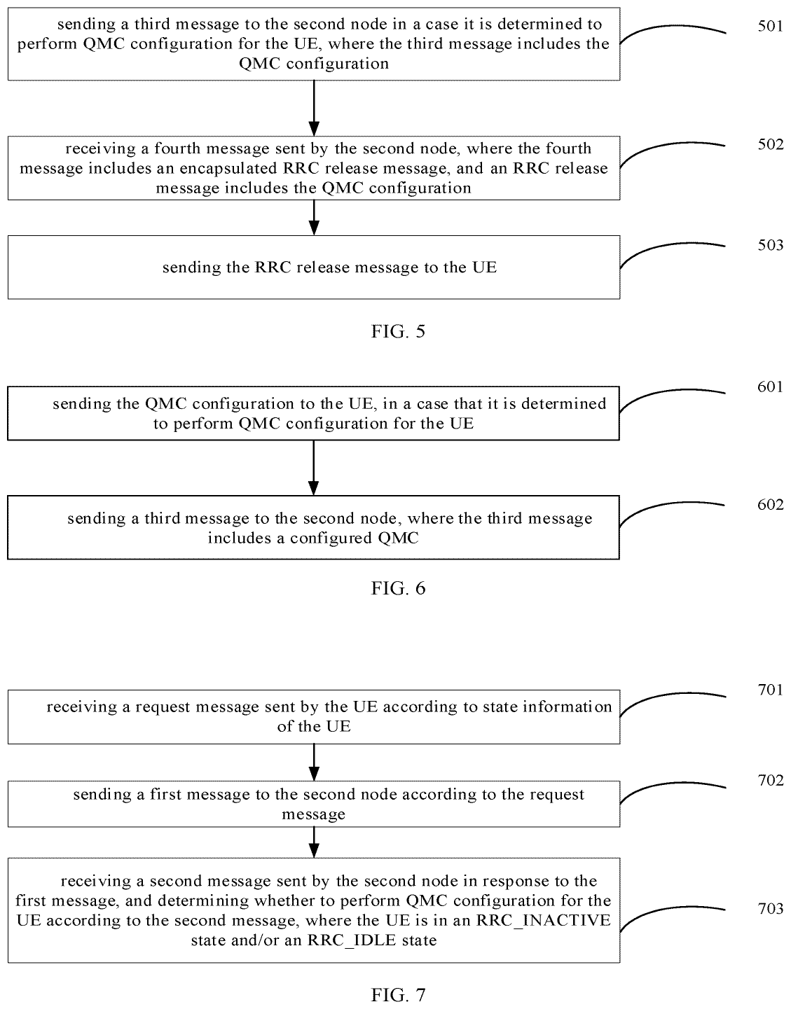

FIG. 5 is a schematic flowchart of a method for QMC configuration provided by an embodiment of the present disclosure. The method is executed by a first node. As shown in FIG. 5, the method may include the following steps.
Step 501: sending a third message to the second node in a case it is determined to perform QMC configuration for the UE, where the third message includes the QMC configuration.
Step 502: receiving a fourth message sent by the second node, where the fourth message includes an encapsulated RRC release message, and the RRC release message includes the QMC configuration.
Step 503: sending the RRC release message to the UE.

In an embodiment of the present disclosure, the third message refers to the message sent to the second node after the first node determines to perform QMC configuration for the UE. The third in the third message is only used to distinguish the third message from other messages and does not specifically refer to a specific message.

In an embodiment of the present disclosure, the fourth message refers to the message sent by the second node to the first node in response to the third message, and the “fourth” in the fourth message is only used to distinguish the fourth message from other messages and does not specifically refer to a specific message.

Illustratively, in an embodiment of the present disclosure, the fourth message sent by the second node includes an RRC release message, and the RRC release message includes a QMC configuration, that is, the second node can encapsulate the QMC configuration into the RRC release message, and send the encapsulated RRC release message to the first node in the form of a fourth message.

In summary, in the embodiments of the present disclosure, if it is determined to perform QMC configuration for the UE, a third message is sent to the second node, where the third message includes the QMC configuration; a fourth message sent by the second node is received, where the fourth message includes an encapsulated RRC release message, and the RRC release message includes the QMC configuration; and an RRC release message is sent to the UE. In the embodiments of the present disclosure, a solution for determining to perform QMC configuration for the UE and sending the third message to the second node is specifically disclosed, which can facilitate the node having the context of the UE to manage the QMC configuration of the UE, can improve the accuracy of sending the QMC configuration to the UE, and improve the accuracy of obtaining QMC information.

It should be understood that the above embodiments may be implemented alone or in combination with other embodiments of the present application, for example, in combination with some or all of steps 201 to 203, steps 301 to 303, or steps 401 to 403, etc., and the present disclosure is not limited thereto.

FIG. 6 is a flowchart of a method for QMC configuration provided by an embodiment of the present disclosure. The method is executed by a first node. As shown in FIG. 6, the method may include the following steps.
Step 601. sending the QMC configuration to the UE, in a case that it is determined to perform QMC configuration for the UE.
Step 602: sending a third message to the second node, where the third message includes a configured QMC.

In an embodiment of the present disclosure, when the second node receives the third message sent by the first node, the second node may save the configured QMC.

In an embodiment of the present disclosure, the configured QMC may include at least one of the following information:
a QoE reference;
a service type;
a communication type;
effective time of the configuration; or
a QMC type.

In an embodiment of the present disclosure, the QMC type may be, for example, a signaling QMC-based type, or a management QMC-based type.

In an embodiment of the present disclosure, the third message refers to the message sent by the first node to the second node after the first node has sent the QMC configuration to the UE. The “third” in the third message is only used to distinguish the third message from other messages and does not specifically refer to a specific message.

It should be understood that the above embodiments may be implemented alone or in combination with other embodiments of the present application, for example, in combination with some or all of steps 201 to 203, steps 301 to 303, or steps 401 to 403, etc., and the present disclosure is not limited thereto.

In summary, in the embodiment of the present disclosure, if it is determined to perform the QMC configuration for the UE, the QMC configuration is sent to the UE; and a third message is sent to the second node, where the third message includes the configured QMC. In the embodiment of the present disclosure, a solution is specifically disclosed in which, after it is determined to perform QMC configuration for the UE, the QMC configuration is sent to the UE, and then the third message is sent to the second node, which can facilitate the node with the UE context to manage the QMC configuration of UE, improve the accuracy of sending the QMC configuration to the UE, and improve the accuracy of obtaining QMC information.

FIG. 7 is a flowchart of a method for QMC configuration provided by an embodiment of the present disclosure. The method is executed by a first node. As shown in FIG. 7, the method may include the following steps.
Step 701: receiving a request message sent by the UE according to state information of the UE.
Step 702: sending a first message to the second node according to the request message.
Step 703: receiving a second message sent by the second node in response to the first message, and determining whether to perform QMC configuration for the UE according to the second message, where the UE is in a radio resource control inactive RRC_INACTIVE state and/or a radio resource control idle RRC_IDLE state.

In an embodiment of the present disclosure, the request message includes at least one of the following:
an RRC resume request (RRC Resume Request) message, where a resume cause in the RRC Resume Request message is QMC-related information; or
an RRC setup request (RRC Setup Request) message, where a cause in the RRC Setup Request message is the QMC-related information.

In an embodiment of the present disclosure, if the UE has one or more sessions in progress, the UE may send an RRC Resume Request message to the first node, where the RRC Resume Request message includes a resume cause, and the resume cause may be information related to QoE, such as a QoE or QMC indication.

In an embodiment of the present disclosure, if the UE is in an idle state, the UE may send an RRC Setup Request message to the first node, where the RRC Setup Request message includes a cause, which may be information related to QoE, such as a QoE or QMC indication.

In an embodiment of the present disclosure, the first node and the second node are both base stations; or
the first node is a base station and the second node is a core network node.

It should be understood that the above embodiments may be implemented alone or in combination with other embodiments of the present application, for example, in combination with some or all of steps 201 to 203, steps 301 to 303, or steps 401 to 403, etc., and the present disclosure is not limited thereto.

In summary, in the embodiments of the present disclosure, a request message sent by a UE according to the state information of the UE is received; a first message is sent to a second node according to the request message; a second message sent by the second node in response to the first message is received, and according to the second message, it is determined whether to perform QMC configuration for the UE, where the UE is in a radio resource control inactive RRC_INACTIVE state and/or a radio resource control idle RRC_IDLE state. In the embodiments of the present disclosure, a QMC configuration mechanism can be provided when the UE is in an RRC_INACTIVE state and/or an RRC_IDLE state, so as to avoid the situation where QMC configuration cannot be performed for the UE in the RRC_INACTIVE state and/or the RRC_IDLE state, and the accuracy of QMC information acquisition can be improved, and the convenience of optimizing services in the RRC_INACTIVE and RRC_IDLE states can be improved. The embodiments of the present disclosure specifically disclose a solution for sending a first message according to a request message sent according to the state information of the UE. The present disclosure provides a processing method for a “QMC configuration” situation to provide a QMC configuration mechanism when the UE is in the RRC_INACTIVE state and/or the RRC_IDLE state, thus improving the accuracy of QMC information acquisition, improving the convenience of optimizing services in the RRC_INACTIVE and RRC_IDLE states, and reducing signaling overhead to save power for the UE.

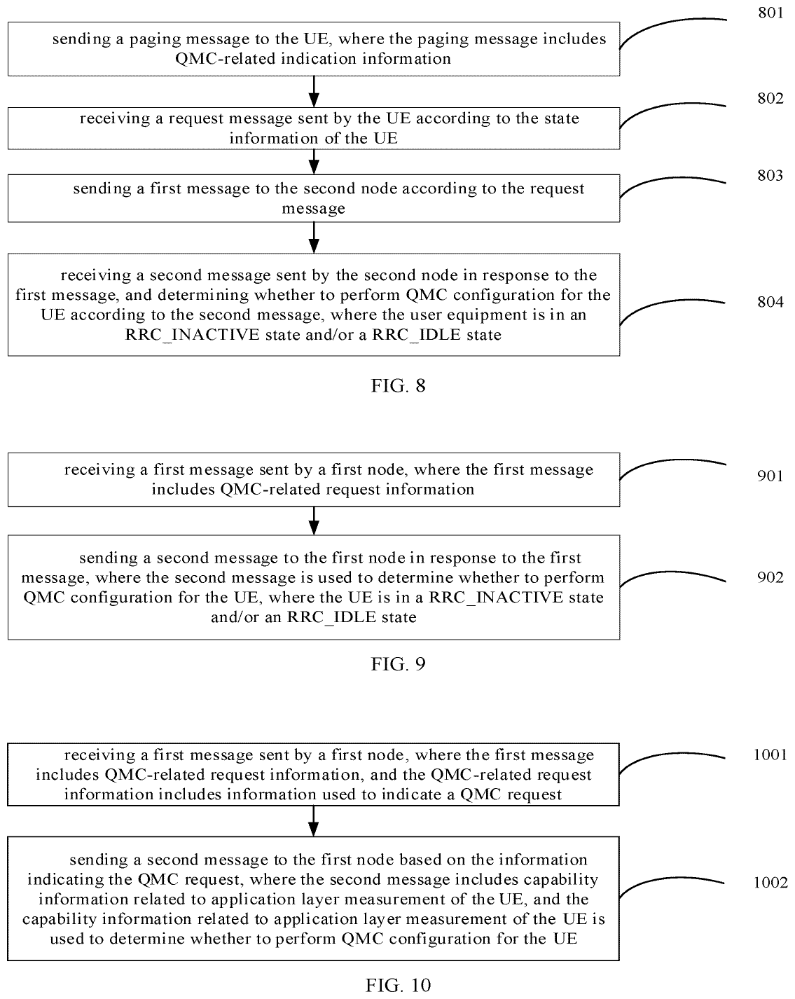

FIG. 8 is a flowchart of a method for QMC configuration provided by an embodiment of the present disclosure. The method is executed by a first node. As shown in FIG. 8, the method may include the following steps.
Step 801: sending a paging message to a UE, where the paging message includes QMC-related indication information.
Step 802: receiving a request message sent by the UE according to the state information of the UE.
Step 803: sending a first message to the second node according to the request message.
Step 804: receiving a second message sent by the second node in response to the first message, and determining whether to perform QMC configuration for the UE according to the second message, where the UE is in a radio resource control inactive RRC_INACTIVE state and/or a radio resource control idle RRC_IDLE state.

In an embodiment of the present disclosure,
the first node and the second node are both base stations;
the first node is a base station and the second node is a core network node.

In an embodiment of the present disclosure, the first node may send a paging message to the UE, and the UE may send an RRC Resume Request message or an RRC Setup Request message to the first node in response to the paging message sent by the first node. The UE may determine the specific type of the request message according to the state information of the UE.

In summary, in the embodiment of the present disclosure, a paging message is sent to a UE, where the paging message includes QMC-related indication information; a request message sent by the UE according to the state information of the UE is received; a first message is sent to a second node according to the request message; a second message sent by the second node in response to the first message is received, and according to the second message, it is determined whether to perform QMC configuration for the UE, where the UE is in a radio resource control inactive RRC_INACTIVE state and/or a radio resource control idle RRC_IDLE state. In the embodiment of the present disclosure, a QMC configuration mechanism can be provided when the UE is in an RRC_INACTIVE state and/or an RRC_IDLE state, thus avoiding the situation where QMC configuration cannot be performed for the UE in the RRC_INACTIVE state and/or the RRC_IDLE state, which can improve the accuracy of QMC information acquisition and improve the convenience of optimizing services in RRC_INACTIVE and RRC_IDLE states. The embodiment of the present disclosure specifically discloses a scheme for sending a paging message to a UE. The present disclosure provides a processing method for a “QMC configuration” situation to provide a QMC configuration mechanism when the UE is in the RRC_INACTIVE state and/or the RRC_IDLE state, thus improving the accuracy of QMC information acquisition, improving the convenience of optimizing services in the RRC_INACTIVE and RRC_IDLE states, and reducing signaling overhead to save power for the UE.

FIG. 9 is a flowchart of a method for QMC configuration provided by an embodiment of the present disclosure. The method is executed by the second node. As shown in FIG. 9, the method may include the following steps.
Step 901: receiving a first message sent by a first node, where the first message includes QMC-related request information.
Step 902: sending a second message to the first node in response to the first message, where the second message is used to determine whether to perform QMC configuration for the UE, where the UE is in a radio resource control inactive RRC_INACTIVE state and/or a radio resource control idle RRC_IDLE state.

In an embodiment of the present disclosure, the QMC-related request information includes information indicating the QMC request, and sending a second message to the first node in response to the first message includes:
sending a second message to the first node based on the information indicating the QMC request, where the second message includes capability information related to application layer measurement of the UE, and the capability information related to application layer measurement of the UE is used to determine whether to perform QMC configuration for the UE.

In an embodiment of the present disclosure, sending a second message to the first node according to information indicating a QMC request includes:
sending a second message to the first node based on the information indicating the QMC request and based on determination as to not perform context relocation on the UE.

In an embodiment of the present disclosure, the second message includes at least one of the following:
a partial UE context transfer (Partial UE Context Transfer) message;
a UE QMC context transfer (UE QMC Context Transfer) message;
a retrieve UE context failure (Retrieve UE Context Failure) message; or
another Xn Application Protocol (XnAP) message.

Illustratively, in an embodiment of the present disclosure, the QMC-related request information includes the requested service type, and sending the second message to the first node in response to the first message includes:
sending the second message to the first node based on capability of the UE and the requested service type, where the second message includes QMC support indication information of the UE, and the QMC support indication information of the UE is used to determine whether to perform the QMC configuration for the UE.

Illustratively, in an embodiment of the present disclosure, the QMC-related request information further includes at least one of the following:
information indicating a QMC request; or
a requested communication type.

In an embodiment of the present disclosure, the QMC-related request information includes QMC configuration, and sending the second message to the first node in response to the first message includes:
determining, based on the capability of the UE and the QMC configuration, to perform the QMC configuration for the UE;
sending the second message to the first node, where the second message includes an encapsulated RRC release message, and an RRC release message includes the QMC configuration.

Optionally, in an embodiment of the present disclosure, the second message also includes indication information that determines to perform the QMC configuration.

In an embodiment of the present disclosure, after sending the second message to the first node, the method further includes:
receiving a third message from the first node, where the third message includes the QMC configuration; and
sending a fourth message to the first node, where the fourth message includes an encapsulated RRC release message, and the RRC release message contains the QMC configuration.

In an embodiment of the present disclosure, after sending the second message to the first node, the method further includes:
receiving a third message from the first node, where the third message includes a configured QMC.

Furthermore, in an embodiment of the present disclosure,
both the first node and the second node are base stations;
or
the first node is a base station, and the second node is a core network node.

In summary, in the embodiment of the present disclosure, a first message sent by a first node is received, where the first message includes QMC-related request information; in response to the first message, a second message is sent to the first node, where the second message is used to determine whether to perform QMC configuration for the UE, where the UE is in a radio resource control inactive RRC_INACTIVE state and/or a radio resource control idle RRC_IDLE state. In the embodiment of the present disclosure, a QMC configuration mechanism can be provided when the UE is in an RRC_INACTIVE state and/or an RRC_IDLE state, thereby avoiding the situation where the first node cannot perform QMC configuration for the UE in the RRC_INACTIVE state and/or the RRC_IDLE state, thereby improving the accuracy of QMC information acquisition and the convenience of optimizing services in the RRC_INACTIVE and RRC_IDLE modes. The present disclosure provides a processing method for a “QMC configuration” situation to provide a QMC configuration mechanism when the UE is in the RRC_INACTIVE state and/or the RRC_IDLE state, thus improving the accuracy of QMC information acquisition, improving the convenience of optimizing services in the RRC_INACTIVE and RRC_IDLE states, and reducing signaling overhead to save power for the UE.

FIG. 10 is a flowchart of a method for QMC configuration provided by an embodiment of the present disclosure. The method is executed by the second node. As shown in FIG. 10, the method may include the following steps.
Step 1001: receiving a first message sent by a first node, where the first message includes QMC-related request information, and the QMC-related request information includes information used to indicate a QMC request.
Step 1002: sending a second message to the first node based on the information indicating the QMC request, where the second message includes capability information related to application layer measurement of the UE, and the capability information related to application layer measurement of the UE is used to determine whether to perform QMC configuration for the UE.

In an embodiment of the present disclosure, the UE is in a radio resource control inactive RRC_INACTIVE state and/or a radio resource control idle RRC_IDLE state.

In an embodiment of the present disclosure, sending a second message to the first node based on information indicating a QMC request includes:
sending the second message to the first node based on the information indicating the QMC request and based on determination as to not perform context relocation on the UE.

In an embodiment of the present disclosure, the second message includes at least one of the following:
a partial UE context transfer (Partial UE Context Transfer) message;
a UE QMC context transfer (UE QMC Context Transfer) message;
a retrieve UE context failure (Retrieve UE Context Failure) message; or
another Xn Application Protocol (XnAP) message.

In summary, in the embodiment of the present disclosure, a first message sent by a first node is received, where the first message includes QMC-related request information, and the QMC-related request information includes information indicating the QMC request; a second message is sent to the first node based on the information indicating a QMC request, where the second message includes capability information related to application layer measurement of the UE, and the capability information related to application layer measurement of the UE is used to determine whether to perform QMC configuration for the UE. In the embodiment of the present disclosure, a QMC configuration mechanism can be provided when the UE is in the RRC_INACTIVE state and/or the RRC_IDLE state, thus avoiding the situation where the first node cannot perform QMC configuration for the UE in the RRC_INACTIVE state and/or the RRC_IDLE state, which can improve the accuracy of QMC information acquisition and improve the convenience of optimizing services in the RRC_INACTIVE and RRC_IDLE states. The embodiment of the present disclosure specifically discloses a solution in which the QMC-related request information includes information indicating the QMC request. The present disclosure provides a processing method for a “QMC configuration” situation to provide a QMC configuration mechanism when the UE is in the RRC_INACTIVE state and/or the RRC_IDLE state, thus improving the accuracy of QMC information acquisition, improving the convenience of optimizing services in the RRC_INACTIVE and RRC_IDLE modes, and reducing signaling overhead to save power for the UE.

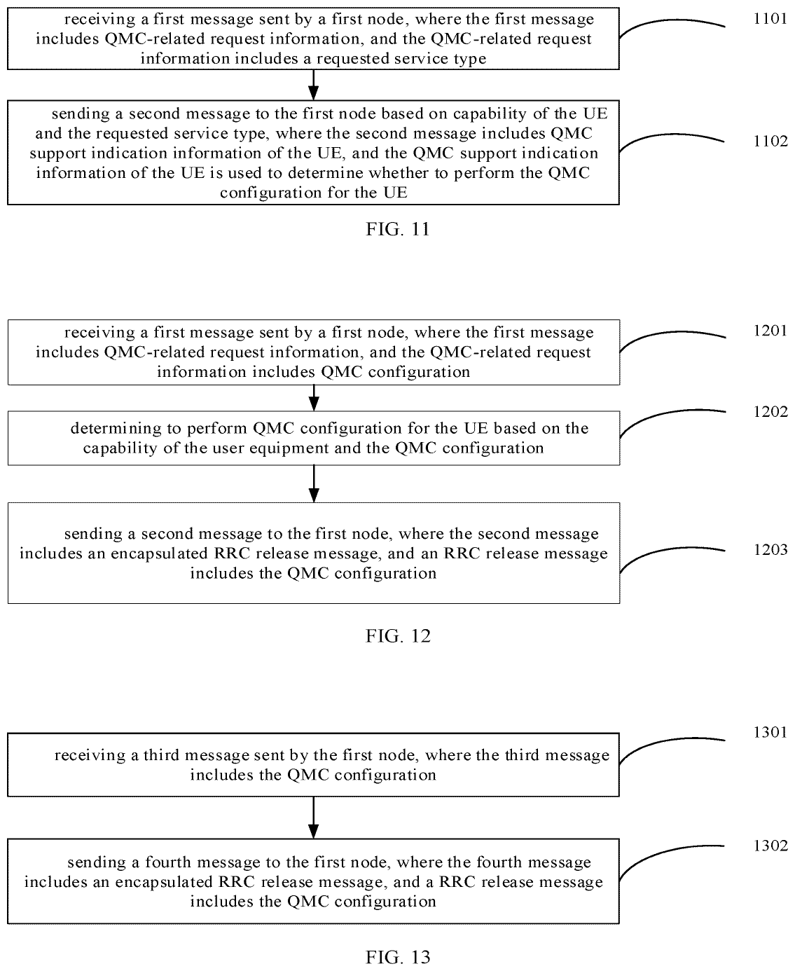

FIG. 11 is a flowchart of a method for QMC configuration provided by an embodiment of the present disclosure. The method is executed by the second node. As shown in FIG. 11, the method may include the following steps.
Step 1101: receiving a first message sent by a first node, where the first message includes QMC-related request information, and the QMC-related request information includes a requested service type;
Step 1102: sending a second message to the first node based on capability of the UE and the requested service type, where the second message includes QMC support indication information of the UE, and the QMC support indication information of the UE is used to determine whether to perform the QMC configuration for the UE.

In an embodiment of the present disclosure, the UE is in a radio resource control inactive RRC_INACTIVE state and/or a radio resource control idle RRC_IDLE state.

In an embodiment of the present disclosure, the QMC-related request information further includes at least one of the following:
information indicating a QMC request; or
a requested communication type.

In summary, in the embodiment of the present disclosure, the second node receives the first message sent by the first node, where the first message includes QMC-related request information, and the QMC-related request information includes the requested service type; the second node sends a second message to the first node based on the capability of the UE and the requested service type, where the second message includes QMC support indication information of the UE, and the QMC support indication information of the UE is used to determine whether to perform QMC configuration for the UE. In the embodiment of the present disclosure, a QMC configuration mechanism can be provided when the UE is in the RRC_INACTIVE state and/or the RRC_IDLE state, thus avoiding the situation where the first node cannot perform QMC configuration for the UE in the RRC_INACTIVE state and/or the RRC_IDLE state, which can improve the accuracy of QMC information acquisition and improve the convenience of optimizing services in the RRC_INACTIVE and RRC_IDLE modes. The embodiment of the present disclosure specifically discloses a solution in which the QMC-related request information includes the requested service type. A processing method is disclosed for a “QMC configuration” situation to provide a QMC configuration mechanism when the UE is in the RRC_INACTIVE state and/or the RRC_IDLE state, thus improving the accuracy of QMC information acquisition, improving the convenience of optimizing services in the RRC_INACTIVE and RRC_IDLE modes, and reducing signaling overhead to save power for the UE.

FIG. 12 is a flowchart of a method for QMC configuration provided by an embodiment of the present disclosure. The method is executed by the second node. As shown in FIG. 12, the method may include the following steps.
Step 1201: receiving a first message sent by a first node, where the first message includes QMC-related request information, and the QMC-related request information includes QMC configuration;
Step 1202: determining to perform QMC configuration for the UE based on the capability of the UE and the QMC configuration;
Step 1203: sending a second message to the first node, where the second message includes an encapsulated RRC release message, and an RRC release message includes the QMC configuration.

In an embodiment of the present disclosure, the UE is in a radio resource control inactive RRC_INACTIVE state and/or a radio resource control idle RRC_IDLE state.

In summary, in the embodiment of the present disclosure, the second node receives the first message sent by the first node, where the first message includes QMC-related request information, and the QMC-related request information includes QMC configuration; performing the QMC configuration of the UE is determined according to the capability of the UE and the QMC configuration; the second node sends a second message to the first node, where the second message includes an encapsulated RRC release message, and the RRC release message includes the QMC configuration. In the embodiment of the present disclosure, a QMC configuration mechanism can be provided when the UE is in the RRC_INACTIVE state and/or the RRC_IDLE state, thus avoiding the situation where the first node cannot perform QMC configuration for the UE in the RRC_INACTIVE state and/or the RRC_IDLE state, which can improve the accuracy of QMC information acquisition and improve the convenience of optimizing services in the RRC_INACTIVE and RRC_IDLE modes. The embodiment of the present disclosure specifically discloses a solution in which the QMC-related request information includes the QMC configuration. A processing method is disclosed for a “QMC configuration” situation to provide a QMC configuration mechanism when the UE is in the RRC_INACTIVE state and/or the RRC_IDLE state, thus improving the accuracy of QMC information acquisition, improving the convenience of optimizing services in the RRC_INACTIVE and RRC_IDLE modes, and reducing signaling overhead to save power for the UE.

FIG. 13 is a flowchart of a method for QMC configuration provided by an embodiment of the present disclosure. The method is executed by the second node. As shown in FIG. 13, the method may include the following steps.
Step 1301: receiving a third message sent by the first node, where the third message includes the QMC configuration.
Step 1302: sending a fourth message to the first node, where the fourth message includes an encapsulated RRC release message, and an RRC release message includes the QMC configuration.

In an embodiment of the present disclosure, if it is determined to perform QMC configuration for the UE, the first node may send a third message to the second node, where the third message includes the QMC configuration. The second node may receive the third message sent by the first node, where the third message includes the QMC configuration. The second node may send a fourth message to the first node, where the fourth message includes an encapsulated RRC release message, and the RRC release message includes the QMC configuration. The first node may receive the fourth message sent by the second node, and the first node may send an RRC release message to the UE.

It should be understood that the above embodiments may be implemented individually or in combination with other embodiments of the present application, and the present disclosure is not limited thereto.

In summary, in the embodiment of the present disclosure, the second node receives the third message sent by the first node, where the third message includes the QMC configuration; the second node sends a fourth message to the first node, where the fourth message includes an encapsulated RRC release message, and the RRC release message includes the QMC configuration. In the embodiment of the present disclosure, a solution for determining to perform QMC configuration on a UE, receiving the third message sent by the first node, and sending the fourth message to the first node is specifically disclosed, which can facilitate the node with a UE context to manage the QMC configuration of the UE, improve the accuracy of sending the QMC configuration to the UE, and improve the accuracy of obtaining QMC information.

FIG. 14 is a flowchart of a method for QMC configuration provided in an embodiment of the present disclosure. The method is executed by the second node. As shown in FIG. 14, the method may include the following steps.
Step 1401: receiving a first message sent by a first node, where the first message includes QMC-related request information.
Step 1402: sending a second message to the first node in response to the first message, where the second message is used to determine whether to perform QMC configuration for the UE, where the UE is in a radio resource control inactive RRC_INACTIVE state and/or a radio resource control idle RRC_IDLE state.
Step 1403: receiving a third message sent by the first node, where the third message includes a configured QMC.

In an embodiment of the present disclosure, the configured QMC may include at least one of the following information:
a QoE reference;
a service type;
a communication type;
effective time of the configuration; or
a Qmc type.

In an embodiment of the present disclosure, the QMC type may be, for example, a signaling QMC-based type, or a management QMC-based type.

Furthermore, in an embodiment of the present disclosure, if it is determined to perform QMC configuration for the UE, the first node may send a third message to the second node, where the third message includes the configured QMC. The second node may save the configured QMC.

It should be understood that the above embodiments may be implemented individually or in combination with other embodiments of the present application, and the present disclosure is not limited thereto.

In summary, in the embodiment of the present disclosure, after the second node sends the second message to the first node, the second node can receive the third message sent by the first node, where the third message includes the configured QMC. In the embodiment of the present disclosure, a solution of receiving the third message sent by the first node after sending the second message to the first node is specifically disclosed, which can facilitate the node with the UE context to manage the QMC configuration of the UE, improve the accuracy of sending the QMC configuration to the UE, and improve the accuracy of obtaining the QMC information.

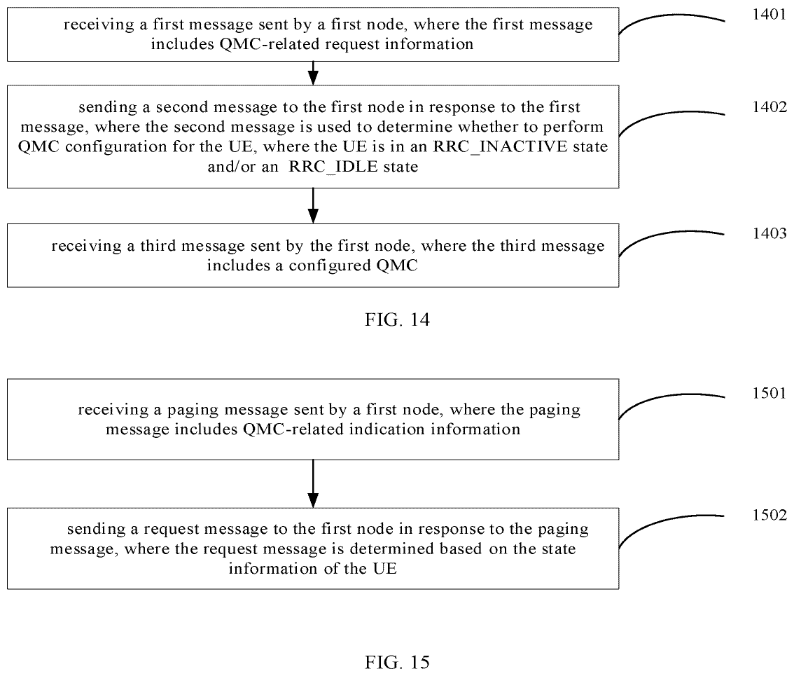

FIG. 15 is a flowchart of a method for QMC configuration provided by an embodiment of the present disclosure. The method is executed by a UE. As shown in FIG. 15, the method may include the following steps.
Step 1501: receiving a paging message sent by a first node, where the paging message includes QMC-related indication information.
Step 1502: sending a request message to the first node in response to the paging message, where the request message is determined based on the state information of the UE.

In an embodiment of the present disclosure, the request message includes at least one of the following:
a radio resource control resume request (RRC Resume Request) message, where a resume cause in the RRC Resume Request is QMC-related information; or
a radio resource control setup request (RRC Setup Request) message, where a cause in the RRC Setup Request is the QMC-related information.

It should be understood that the above embodiments may be implemented individually or in combination with other embodiments of the present application, and the present disclosure is not limited thereto.

In summary, in the embodiment of the present disclosure, the second node receives a paging message sent by the first node, where the paging message includes QMC-related indication information; in response to the paging message, the second node sends a request message to the first node, where the request message is determined according to the state information of the UE. In the embodiment of the present disclosure, a request message can be sent to the first node in response to the paging message, thereby avoiding the situation where the request message does not correspond to the state information of the UE, and the accuracy of QMC information acquisition can be improved, and the convenience of optimizing services in RRC_INACTIVE and RRC_IDLE modes can be improved. The present disclosure provides a processing method for a “QMC configuration” situation, so as to send a request message to the first node according to the state information of the UE, thus improving the accuracy of QMC information acquisition, improving the convenience of optimizing services in RRC_INACTIVE and RRC_IDLE modes, and reducing signaling overhead to save power for the UE.

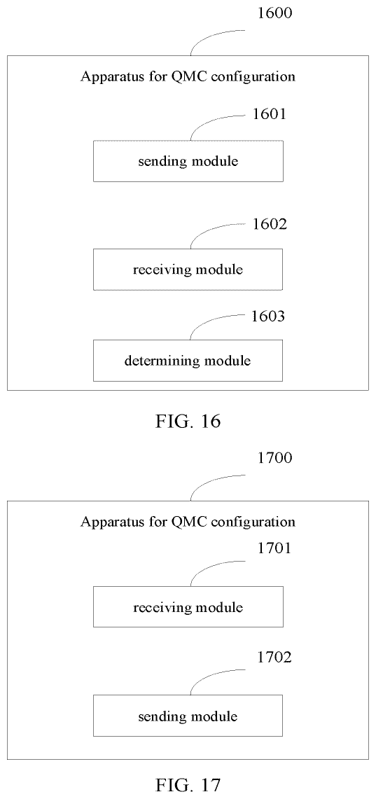

FIG. 16 is a schematic diagram of the structure of an apparatus for QMC configuration provided by an embodiment of the present disclosure. As shown in FIG. 16, the apparatus 1600 may be in a first node, and the apparatus 1600 may include:
a sending module 1601, configured to send a first message to a second node, where the first message includes QMC-related request information;
a receiving module 1602, configured to receive a second message sent by the second node in response to the first message; and
a determining module 1603, configured to determine, based on the second message, whether to perform QMC configuration for the UE, where the UE is in a radio resource control inactive RRC_INACTIVE state and/or a radio resource control idle RRC_IDLE state.

In summary, in the apparatus for QMC configuration of the embodiment of the present disclosure, a first message can be sent to a second node through a sending module, where the first message includes QMC-related request information; a receiving module can receive a second message sent by the second node in response to the first message; and the determining module 1603 is configured to determine, based on the second message, whether to perform QMC configuration on a UE, where the UE is in a radio resource control inactive RRC_INACTIVE state and/or a radio resource control idle RRC_IDLE state. In the embodiment of the present disclosure, a QMC configuration mechanism can be provided when the UE is in an RRC_INACTIVE state and/or an RRC_IDLE state, thus avoiding the situation where the QMC configuration cannot be performed for the UE in the RRC_INACTIVE state and/or the RRC_IDLE state, which can improve the accuracy of QMC information acquisition and improve the convenience of optimizing services in RRC_INACTIVE and RRC_IDLE modes. The present disclosure provides a processing device for a “QMC configuration” situation to provide a QMC configuration mechanism when the UE is in the RRC_INACTIVE state and/or the RRC_IDLE state, thus improving the accuracy of QMC information acquisition, improving the convenience of optimizing services in the RRC_INACTIVE and RRC_IDLE modes, and reducing signaling overhead to save power for the UE.

Optionally, in an embodiment of the present disclosure, the QMC-related request information includes information indicating the QMC request, and the receiving module 1602 is specifically configured to, when receiving a second message sent by the second node in response to the first message,
receive a second message sent by the second node based on the information indicating the QMC request, where the second message includes capability information related to application layer measurement of the UE.

Furthermore, the determining module 1603 is specifically configured to, when determining whether to perform QMC configuration for the UE according to the second message, determine whether to perform QMC configuration for the UE based on capability information related to application layer measurement of the UE.

Optionally, in an embodiment of the present disclosure, the QMC-related request information includes the requested service type, and the receiving module 1602 is specifically configured to, when receiving a second message sent by the second node in response to the first message,
receive a second message sent by the second node based on the capability of the UE and the requested service type, where the second message includes QMC support indication information of the UE.

Furthermore, the determining module 1603 is specifically configured to, when determining whether to perform quality of experience measurement collection QMC configuration for the UE based on the second message,
determine whether to perform QMC configuration for the UE based on the QMC support indication information of the UE.

Optionally, in an embodiment of the present disclosure, the QMC-related request information further includes at least one of the following:
information indicating a QMC request; or
a requested communication type.

Optionally, in an embodiment of the present disclosure, the QMC-related request information includes a QMC configuration, and the receiving module 1602 is specifically configured to, when receiving a second message sent by the second node in response to the first message,
receive a second message sent by the second node based on the capability of the UE and the QMC configuration, where the second message includes an encapsulated RRC release message, and the RRC release message includes the QMC configuration.

Furthermore, the sending module 1601 is further configured to
forward the RRC release message to the UE.

Optionally, in an embodiment of the present disclosure, the second message also includes indication information that determines to perform QMC configuration.

Optionally, in an embodiment of the present disclosure, the indication information that determines to perform QMC configuration may be one or more QoE references.

Optionally, in an embodiment of the present disclosure, the receiving module 1602 is specifically configured to, when determining whether to perform QMC configuration for the UE,
if it is determined to perform QMC configuration for the UE, send a third message to the second node, where the third message includes the QMC configuration;
receive a fourth message sent by the second node, where the fourth message includes an encapsulated RRC release message, and the RRC release message includes a QMC configuration; and
send an RRC release message to the UE.

Optionally, in an embodiment of the present disclosure, the receiving module 1602 is specifically configured to, when determining whether to perform QMC configuration for the UE,
if it is determined to perform QMC configuration for the UE, send the QMC configuration to the UE; and
send a third message to the second node, where the third message includes a configured QMC.

Optionally, in an embodiment of the present disclosure, the sending module 1601 is specifically configured to, when sending the first message to the second node,
receive a request message sent by the UE based on the state information of the UE; and
based on the request message, send a first message to the second node.

Optionally, in an embodiment of the present disclosure, the request message includes at least one of the following:
a radio resource control resume request (RRC Resume Request) message, where a resume cause in the RRC Resume Request is QMC-related information; or
a radio resource control setup request (RRC Setup Request) message, where a cause in the RRC Setup Request is the QMC-related information.

Optionally, in an embodiment of the present disclosure, the sending module 1601 is specifically configured to, before receiving a request message sent by a UE according to the state information of the UE,
send a paging message to the UE, where the paging message includes QMC-related indication information.

Optionally, in an embodiment of the present disclosure,
the first node and the second node are both base stations; or
the first node is a base station and the second node is a core network node.

FIG. 17 is a schematic diagram of the structure of an apparatus for QMC configuration provided by an embodiment of the present disclosure. As shown in FIG. 17, the apparatus 1700 may be in a second node, and the apparatus 1700 may include:
a receiving module 1701, configured to receive a first message sent by a first node, where the first message includes QMC-related request information; and
a sending module 1702, configured to send a second message to the first node in response to the first message, where the second message is used to determine whether to perform QMC configuration for the UE, where the UE is in a radio resource control inactive RRC_INACTIVE state and/or a radio resource control idle RRC_IDLE state.

In summary, in the apparatus for QMC configuration of the embodiment of the present disclosure, a first message sent by a first node can be received through the receiving module, where the first message includes QMC-related request information; the sending module can send a second message to the first node in response to the first message, where the second message is used to determine whether to perform QMC configuration for the UE, where the UE is in a radio resource control inactive RRC_INACTIVE state and/or a radio resource control idle RRC_IDLE state. In the embodiment of the present disclosure, a QMC configuration mechanism can be provided when the UE is in an RRC_INACTIVE state and/or an RRC_IDLE state, thereby avoiding the situation where the first node cannot perform QMC configuration for the UE in an RRC_INACTIVE state and/or an RRC_IDLE state, thereby improving the accuracy of QMC information acquisition and the convenience of optimizing services in RRC_INACTIVE and RRC_IDLE modes. The present disclosure provides a processing device for a “QMC configuration” situation to provide a QMC configuration mechanism when the UE is in the RRC_INACTIVE state and/or the RRC_IDLE state, thus improving the accuracy of QMC information acquisition, improving the convenience of optimizing services in the RRC_INACTIVE and RRC_IDLE modes, and reducing signaling overhead to save power for the UE.

Optionally, in an embodiment of the present disclosure, the QMC-related request information includes information indicating the QMC request, and the sending module 1702 is specifically configured to, when sending the second message to the first node in response to the first message,
send a second message to the first node based on the information indicating the QMC request, where the second message includes capability information related to application layer measurement of the UE, and the capability information related to application layer measurement of the UE is used to determine whether to perform QMC configuration for the UE.

Optionally, in an embodiment of the present disclosure, the sending module 1702 is specifically configured to, when sending the second message to the first node based on the information indicating the QMC request,
send a second message to the first node based on the information indicating the QMC request and based on determination as to not perform context relocation on the UE.

Optionally, in an embodiment of the present disclosure, the second message includes at least one of the following:
a partial UE context transfer (Partial UE Context Transfer) message;
a UE QMC context transfer (UE QMC Context Transfer) message;
a retrieve UE context failure (Retrieve UE Context Failure) message; or
another Xn Application Protocol (XnAP) message.

Optionally, in an embodiment of the present disclosure, the QMC-related request information includes the requested service type, and the sending module 1702 is specifically configured to, when sending the second message to the first node in response to the first message, send a second message to the first node based on the capability of the UE and the requested service type, where the second message includes QMC support indication information of the UE, and the QMC support indication information of the UE is used to determine whether to perform QMC configuration for the UE.

Optionally, in an embodiment of the present disclosure, the QMC-related request information further includes at least one of the following:
information indicating a QMC request; or
a requested communication type.

Optionally, in an embodiment of the present disclosure, the QMC-related request information includes QMC configuration, and the sending module 1702 is specifically configured to, when sending the second message to the first node in response to the first message,
perform QMC configuration for the UE based on the capability of the UE and the QMC configuration;
send a second message to the first node, where the second message includes an encapsulated RRC release message, and the RRC release message includes the QMC configuration.

Optionally, in an embodiment of the present disclosure, the second message also includes indication information that determines to perform the QMC configuration.

Optionally, in an embodiment of the present disclosure, the sending module 1702 is further configured to, after sending the second message to the first node,
receive a third message sent by the first node, where the third message includes a QMC configuration;
send a fourth message to the first node, where the fourth message includes an encapsulated RRC release message, and the RRC release message includes a QMC configuration.

Optionally, in an embodiment of the present disclosure, the sending module 1702 is further configured to, after sending the second message to the first node,
receive a third message sent by the first node, where the third message includes a configured QMC.

Optionally, in an embodiment of the present disclosure:
the first node and the second node are both base stations;
or,
the first node is a base station and the second node is a core network node.

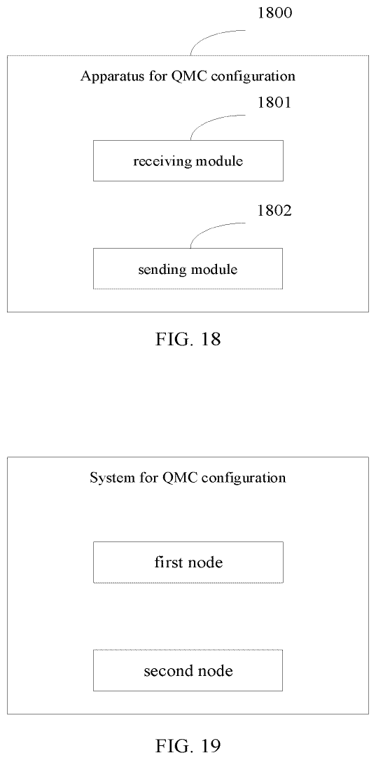

FIG. 18 is a schematic diagram of the structure of an apparatus for QMC configuration provided by an embodiment of the present disclosure. As shown in FIG. 18, the apparatus 1800 may be in a second node, and the apparatus 1800 may include:
a receiving module 1801 configured to receive a paging message sent by the first node, where the paging message includes QMC-related indication information; and
a sending module 1802 configured to send a request message to the first node in response to the paging message, where the request message is determined based on the state information of the UE.

In summary, in the apparatus for QMC configuration of the embodiment of the present disclosure, a paging message sent by the first node can be received through a receiving module, where the paging message includes QMC-related indication information; the sending module can send a request message to the first node in response to the paging message, where the request message is determined according to the state information of the UE. In the embodiment of the present disclosure, a request message can be sent to the first node in response to the paging message, thereby avoiding the situation where the request message does not correspond to the state information of the UE, improving the accuracy of QMC information acquisition, and improving the convenience of optimizing services in RRC_INACTIVE and RRC_IDLE modes. The present disclosure provides a processing method for a “QMC configuration” situation, so as to send a request message to the first node according to the state information of the UE, thus improving the accuracy of QMC information acquisition, improving the convenience of optimizing services in RRC_INACTIVE and RRC_IDLE modes, and reducing signaling overhead to save power for the UE.

Optionally, in an embodiment of the present disclosure, the request message includes at least one of the following:
a radio resource control resume request (RRC Resume Request) message, where a resume cause in the RRC Resume Request is QMC-related information; or
a radio resource control setup request (RRC Setup Request) message, where a cause in the RRC Setup Request is the QMC-related information.

FIG. 19 is a schematic diagram of the structure of a system for QMC configuration provided by an embodiment of the present disclosure. As shown in FIG. 19, the system includes a first node, configured to send a first message to the second node, where the first message contains QMC-related request information; and
a second node, configured to receive the first message from the first node;
where the second node is further configured to send a second message to the first node in response to the first message;
where the first node is further configured to receive the second message sent by the second node in response to the first message, and
where the first node is configured to determine, based on the second message, whether to perform the QMC configuration for the UE, where the UE is in a radio resource control inactive (RRC_INACTIVE) state and/or a radio resource control idle (RRC_IDLE) state.

In summary, in the system for QMC configuration of the embodiment of the present disclosure, the first node is used to send a first message to the second node, where the first message includes QMC-related request information; the second node is used to receive the first message sent by the first node; the second node is used to send a second message to the first node in response to the first message; the first node is used to receive the second message sent by the second node in response to the first message, and the first node is used to determine whether to perform QMC configuration for the UE according to the second message, where the UE is in a radio resource control inactive RRC_INACTIVE state and/or a radio resource control idle RRC_IDLE state. In the embodiment of the present disclosure, a QMC configuration mechanism can be provided when the UE is in an RRC_INACTIVE state and/or an RRC_IDLE state, thereby avoiding the situation where QMC configuration cannot be performed for the UE in the RRC_INACTIVE state and/or the RRC_IDLE state, which can improve the accuracy of QMC information acquisition and improve the convenience of optimizing services in RRC_INACTIVE and RRC_IDLE modes. The present disclosure provides a processing system for a “QMC configuration” situation to provide a QMC configuration mechanism when the UE is in the RRC_INACTIVE state and/or the RRC_IDLE state, thus improving the accuracy of QMC information acquisition, improving the convenience of optimizing services in the RRC_INACTIVE and RRC_IDLE modes, and reducing signaling overhead to save power for the UE.

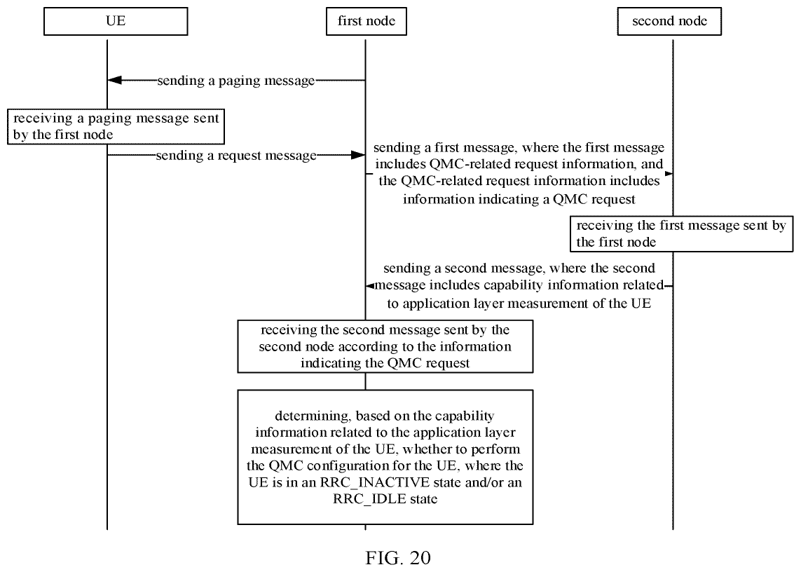

FIG. 20 is an interactive schematic diagram of a method for QMC configuration provided by an embodiment of the present disclosure. As shown in FIG. 20, the system further includes a UE and the method may include the following interactions:
a first node is configured to send a paging message to a UE, where the paging message includes QMC-related indication information;
a UE is configured to receive the paging message sent by the first node;
the UE is further configured to send a request message to the first node in response to the paging message, where the request message is determined based on the state information of the UE;
the first node is further configured to send a first message to the second node, where the first message includes QMC-related request information, and the QMC-related request information includes information indicating a QMC request;
a second node is configured to receive a first message sent by the first node;
the second node is further configured to send a second message to the first node based on the information indicating the QMC request, where the second message includes capability information related to the application layer measurement of the UE;
the first node is configured to receive a second message sent by the second node based on the information indicating the QMC request;
the first node is further configured to determine whether to perform QMC configuration for the UE based on capability information related to application layer measurement of the UE, where the UE is in a radio resource control inactive RRC_INACTIVE state and/or a radio resource control idle RRC_IDLE state.

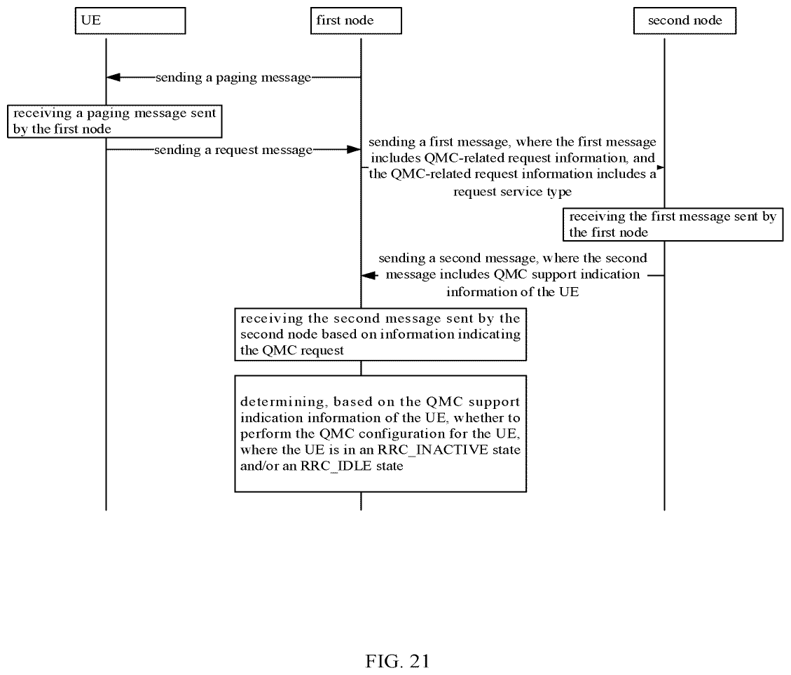

FIG. 21 is an interactive schematic diagram of a method for QMC configuration provided by another embodiment of the present disclosure. As shown in FIG. 21, the system further includes a UE, and the method may further include the following interactions:
a first node is configured to send a paging message to the UE;
the UE is configured to receive a paging message sent by the first node, where the paging message includes QMC-related indication information;
the UE is configured to send a request message to the first node in response to the paging message, where the request message is determined based on the state information of the UE;
the first node is further configured to send a first message to the second node, where the first message includes QMC-related request information, and the QMC-related request information includes a requested service type;
a second node is configured to receive a first message sent by the first node;
the second node is configured to send a second message to the first node based on the capability of the UE and the requested service type, where the second message includes QMC support indication information of the UE;
the first node is further configured to receive a second message sent by the second node based on information indicating the QMC request;
the first node is further configured to determine whether to perform QMC configuration for the UE based on the QMC support indication information of the UE, where the UE is in a radio resource control inactive RRC_INACTIVE state and/or a radio resource control idle RRC_IDLE state.

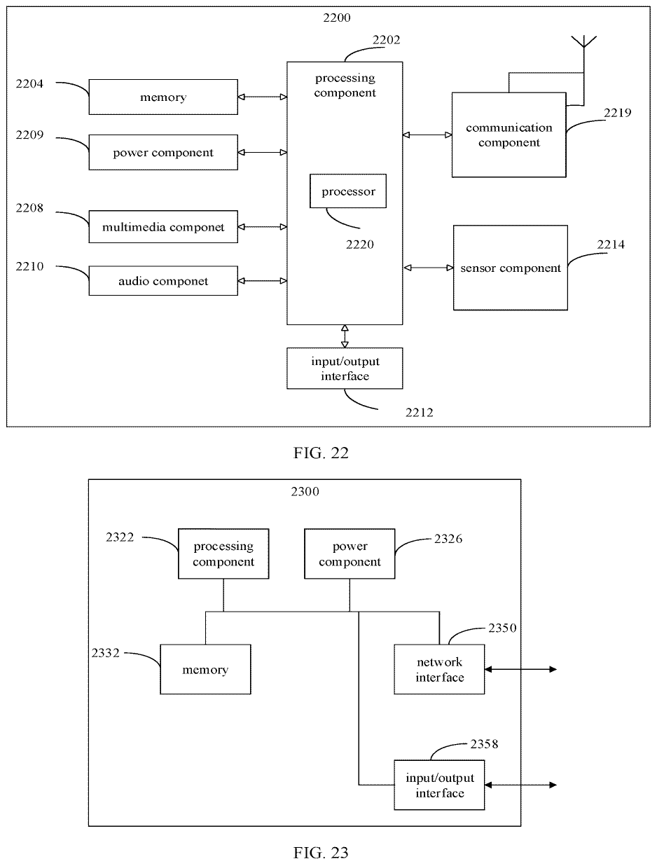

FIG. 22 is a block diagram of a UE 2200 provided by an embodiment of the present disclosure. For example, UE 2200 may be a mobile phone, a computer, a digital broadcast UE, a messaging device, a game console, a tablet device, a medical device, a fitness device, a personal digital assistant, etc.

Referring to FIG. 22, UE 2200 may include at least one of the following components: a processing component 2202, a memory 2204, a power component 2206, a multimedia component 2208, an audio component 2210, an input/output (I/O) interface 2212, a sensor component 2214, and a communication component 2216.

The processing component 2202 generally controls the overall operation of the UE 2200, such as operations associated with display, phone calls, data communications, camera operations, and recording operations. The processing component 2202 may include at least one processor 2220 to execute instructions to complete all or part of the steps of the above-mentioned method. In addition, the processing component 2202 may include at least one module to facilitate the interaction between the processing component 2202 and other components. For example, the processing component 2202 may include a multimedia module to facilitate the interaction between the multimedia component 2208 and the processing component 2202.

The memory 2204 is configured to store various types of data to support operations on the UE 2200. Examples of such data include instructions for any application or method operating on the UE 2200, contact data, phone book data, messages, pictures, videos, etc. The memory 2204 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk, or optical disk.

The power component 2206 provides power to various components of the UE 2200. The power component 2206 may include a power management system, at least one power supply, and other components associated with generating, managing, and distributing power to the UE 2200.

The multimedia component 2208 includes a screen that provides an output interface between the UE 2200 and the user. In some embodiments, the screen may include a liquid crystal display (LCD) and a touch panel (TP). If the screen includes a touch panel, the screen may be implemented as a touch screen to receive input signals from the user. The touch panel includes at least one touch sensor to sense touch, slide, and gestures on the touch panel. The touch sensor may not only sense the boundaries of the touch or slide action, but also detect the wake-up time and pressure associated with the touch or slide operation. In some embodiments, the multimedia component 2208 includes a front camera and/or a rear camera. When the UE 2200 is in an operating mode, such as a shooting mode or a video mode, the front camera and/or the rear camera may receive external multimedia data. Each of the front camera and the rear camera may be a fixed optical lens system or have a focal length and optical zoom capability.

The audio component 2210 is configured to output and/or input audio signals. For example, the audio component 2210 includes a microphone (MIC), and when the UE 2200 is in an operation mode, such as a call mode, a recording mode, and a speech recognition mode, the microphone is configured to receive an external audio signal. The received audio signal may be further stored in the memory 2204 or sent via the communication component 2216. In some embodiments, the audio component 2210 also includes a speaker for outputting audio signals.

The I/O interface 2212 provides an interface between the processing component 2202 and the peripheral interface module, which may be a keyboard, a click wheel, buttons, etc. These buttons may include but are not limited to: a home button, a volume button, a start button, and a lock button.

The sensor assembly 2214 includes at least one sensor for providing various aspects of status assessment for the UE 2200. For example, the sensor assembly 2214 can detect the ON/OFF state of the device 2200, the relative positioning of components, such as the display and keypad of the UE 2200, the sensor assembly 2214 can also detect the position change of the UE 2200 or a component of the UE 2200, the presence or absence of a contact with the UE 2200 of the user, orientation or acceleration/deceleration of the UE 2200 and the temperature change of the UE 2200. The sensor assembly 2214 can include a proximity sensor configured to detect the presence of nearby objects without any physical contact. The sensor assembly 2214 can also include an optical sensor, such as a CMOS or CCD image sensor for use in imaging applications. In some embodiments, the sensor assembly 2214 can also include an acceleration sensor, a gyroscope sensor, a magnetic sensor, a pressure sensor or a temperature sensor.

The communication component 2216 is configured to facilitate wired or wireless communication between the UE 2200 and other devices. The UE 2200 can access a wireless network based on a communication standard, such as WiFi, 2G or 3G, or a combination thereof. In an exemplary embodiment, the communication component 2216 receives a broadcast signal or broadcast-related information from an external broadcast management system via a broadcast channel. In an exemplary embodiment, the communication component 2216 also includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an exemplary embodiment, UE 2200 may be implemented by at least one of an application-specific integrated circuit (ASIC), a digital signal processor (DSP), a digital signal processing device (DSPD), a programmable logic device (PLD), a field programmable gate array (FPGA), a controller, a microcontroller, a microprocessor or other electronic component to perform the above method.

FIG. 23 is a block diagram of a base station 2300 provided in an embodiment of the present disclosure. For example, the base station 2300 may be provided as a network-side device. Referring to FIG. 23, the base station 2300 includes a processing component 2322, which further includes at least one processor, and a memory resource represented by a memory 2332 for storing instructions executable by the processing component 2322, such as an application. The application stored in the memory 2332 may include one or more modules, each corresponding to a set of instructions. In addition, the processing component 2322 is configured to execute instructions to execute any method of the aforementioned method applied to the base station, for example, the method shown in FIG. 1.

The base station 2300 may also include a power supply component 2330 configured to perform power management of the base station 2300, a wired or wireless network interface 2350 configured to connect the base station 2300 to a network, and an input/output (I/O) interface 2358. The base station 2300 may operate based on an operating system stored in the memory 2332, such as Windows Server™, Mac OS X™, Unix™, Linux™, Free BSD™ or the like.

In the above embodiments provided by the present disclosure, the methods provided by the embodiments of the present disclosure are introduced from the perspectives of the network side device and the UE. In order to implement the functions in the methods provided by the above embodiments of the present disclosure, the network side device and the UE may include a hardware structure and a software module, and implement the above functions in the form of a hardware structure, a software module, or a hardware structure plus a software module. One of the above functions may be executed in the form of a hardware structure, a software module, or a hardware structure plus a software module.

In the above embodiments provided by the present disclosure, the methods provided by the embodiments of the present disclosure are introduced from the perspectives of the network side device and the UE. In order to implement the functions in the methods provided by the above embodiments of the present disclosure, the network side device and the UE may include a hardware structure and a software module, and implement the above functions in the form of a hardware structure, a software module, or a hardware structure plus a software module. One of the above functions may be executed in the form of a hardware structure, a software module, or a hardware structure plus a software module.

The present disclosure provides a communication device. The communication device may include a transceiver module and a processing module. The transceiver module may include a sending module and/or a receiving module, the sending module is used to implement a sending function, the receiving module is used to implement a receiving function, and the transceiver module may implement a sending function and/or a receiving function.

The communication device may be a UE (such as the UE in the aforementioned method embodiment), or a device in the UE, or a device that can be used in conjunction with the UE. Optionally, the communication device may be a network device, or a device in the network device, or a device that can be used in conjunction with the network device.

Another communication device is provided in an embodiment of the present disclosure. The communication device may be a network device, or a UE (such as the UE in the aforementioned method embodiment), or a chip, a chip system, or a processor that supports the network device to implement the aforementioned method, or a chip, a chip system, or a processor that supports the UE to implement the aforementioned method. The device may be used to implement the method described in the aforementioned method embodiment, and the details may refer to the description in the aforementioned method embodiment.

The communication device may include one or more processors. The processor may be a general-purpose processor or a dedicated processor, etc. For example, it may be a baseband processor or a central processing unit. The baseband processor may be used to process the communication protocol and communication data, and the central processing unit may be used to control the communication device (such as a network side device, a baseband chip, a UE, a UE chip, a DU or a CU, etc.), execute a computer program, and process the data of the computer program.

Optionally, the communication device may further include one or more memories, on which a computer program may be stored, and the processor executes the computer program so that the communication device performs the method described in the above method embodiment. Optionally, data may also be stored in the memory. The communication device and the memory may be provided separately or integrated together.

Optionally, the communication device may further include a transceiver and an antenna. The transceiver may be referred to as a transceiver unit, a transceiver, or a transceiver circuit, etc., and is used to implement the transceiver function. The transceiver may include a receiver and a transmitter, the receiver may be referred to as a receiver or a receiving circuit, etc., and is used to implement the receiving function; the transmitter may be referred to as a transmitter or a transmitting circuit, etc., and is used to implement the transmitting function.

Optionally, the communication device may further include one or more interface circuits. The interface circuit is used to receive code instructions and transmit them to the processor. The processor runs the code instructions to enable the communication device to execute the method described in the above method embodiment.

The communication device is a base station: the processor is used to execute the method shown in any one of FIG. 1 to FIG. 14.

The communication device is a UE (such as the UE in the aforementioned method embodiment): the processor is used to execute the method shown in FIG. 15.

In one implementation, the processor may include a transceiver for implementing receiving and sending functions. For example, the transceiver may be a transceiver circuit, or an interface, or an interface circuit. The transceiver circuit, interface, or interface circuit for implementing the receiving and sending functions may be separate or integrated. The above-mentioned transceiver circuit, interface, or interface circuit may be used for reading and writing code/data, or the above-mentioned transceiver circuit, interface, or interface circuit may be used for transmitting or delivering signals.

In one implementation, the processor may store a computer program, which runs on the processor and enables the communication device to perform the method described in the above method embodiment. The computer program may be fixed in the processor, in which case the processor may be implemented by hardware.

In one implementation, the communication device may include a circuit, which may implement the functions of sending or receiving or communicating in the aforementioned method embodiment. The processor and transceiver described in the present disclosure may be implemented in an integrated circuit (IC), an analog IC, a radio frequency integrated circuit RFIC, a mixed signal IC, an application specific integrated circuit (ASIC), a printed circuit board (PCB), an electronic device, etc. The processor and transceiver may also be manufactured using various IC process technologies, such as complementary metal oxide semiconductor (CMOS), N-type metal oxide semiconductor (nMetal-oxide-semiconductor, NMOS), P-type metal oxide semiconductor (positive channel metal oxide semiconductor, PMOS), bipolar junction transistor (bipolar junction transistor, BJT), bipolar CMOS (BiCMOS), silicon germanium (SiGe), gallium arsenide (GaAs), etc.

The communication device described in the above embodiments may be a network device or a UE (such as the UE in the aforementioned method embodiment), but the scope of the communication device described in the present disclosure is not limited thereto, and the structure of the communication device may not be limited thereto. The communication device may be an independent device or may be part of a larger device. For example, the communication device may be:
(1) an independent integrated circuit IC, or chip, or chip system or subsystem;
(2) a collection of one or more ICs, optionally including a storage component for storing data or computer programs;
(3) ASIC, such as modem;
(4) modules that can be embedded in other devices;
(5) receivers, UEs, intelligent UEs, cellular phones, wireless devices, handheld devices, mobile units, vehicle-mounted devices, network devices, cloud devices, artificial intelligence devices, etc.;
(6) others.

In the case where the communication device may be a chip or a chip system, the chip includes a processor and an interface, where the number of the processors may be one or more, and the number of the interfaces may be multiple.

Optionally, the chip also includes a memory for storing necessary computer programs and data.

Those skilled in the art may also understand that the various illustrative logical blocks and steps listed in the embodiments of the present disclosure may be implemented by electronic hardware, computer software, or a combination of the two. Whether such functions are implemented by hardware or software depends on the specific application and the design requirements of the entire system. Those skilled in the art may use various methods to implement the functions described for each specific application, but such implementation should not be understood as going beyond the protection scope of the embodiments of the present disclosure.

The present disclosure also provides a readable storage medium having instructions stored thereon, which implement the functions of any of the above method embodiments when executed by a computer.

The present disclosure also provides a computer program product, which implements the functions of any of the above method embodiments when executed by a computer.

In the above embodiments, it can be implemented in whole or in part by software, hardware, firmware or any combination thereof. When implemented by software, it can be implemented in whole or in part in the form of a computer program product. The computer program product includes one or more computer programs. When the computer program is loaded and executed on a computer, the process or function described in the embodiment of the present disclosure is generated in whole or in part. The computer can be a general-purpose computer, a special-purpose computer, a computer network, or other programmable device. The computer program can be stored in a computer-readable storage medium, or transmitted from one computer-readable storage medium to another computer-readable storage medium. For example, the computer program can be transmitted from a website site, computer, server or data center by wired (e.g., coaxial cable, optical fiber, digital subscriber line (DSL)) or wireless (e.g., infrared, wireless, microwave, etc.) mode to another website site, computer, server or data center. The computer-readable storage medium can be any available medium that can be accessed by a computer or a data storage device such as a server or data center that includes one or more available media integrated. The available medium may be a magnetic medium (e.g., a floppy disk, a hard disk, a magnetic tape), an optical medium (e.g., a digital video disc (DVD)), or a semiconductor medium (e.g., a solid state disk (SSD)).

Those skilled in the art can understand that the various numerals such as first and second involved in the present disclosure are only used for distinction for convenience of description and are not used to limit the scope of the embodiments of the present disclosure, and also indicate the order of precedence.

At least one in the present disclosure may also be described as one or more, and a plurality may be two, three, four or more, which is not limited in the present disclosure. In the embodiments of the present disclosure, for a technical feature, the technical features in the technical feature are distinguished by “first”, “second”, “third”, “A”, “B”, “C” and “D”, etc., and there is no order of precedence or size between the technical features described by the “first”, “second”, “third”, “A”, “B”, “C” and “D”.

Those skilled in the art will readily appreciate other embodiments of the present invention after considering the specification and practicing the invention disclosed herein. The present disclosure is intended to cover any variations, uses or adaptations of the present invention that follow the general principles of the present invention and include common knowledge or customary techniques in the art that are not disclosed in the present disclosure. The description and examples are to be considered exemplary only, and the true scope and spirit of the present disclosure are indicated by the following claims.

It should be understood that the present disclosure is not limited to the exact structures that have been described above and shown in the drawings, and that various modifications and changes may be made without departing from the scope thereof. The scope of the present disclosure is limited only by the appended claims.

1. A method for quality of experience measurement collection (QMC) configuration, executed by a first node and comprising:
sending a first message to a second node, wherein the first message comprises QMC-related request information;
receiving a second message sent by the second node in response to the first message; and
determining, based on the second message, whether to perform the QMC configuration for a user equipment (UE), wherein the UE is in at least one of a radio resource control inactive (RRC_INACTIVE) state or a radio resource control idle (RRC_IDLE) state.

2. The method according to claim 1, wherein the QMC-related request information comprises information indicating a QMC request, and receiving the second message sent by the second node in response to the first message comprises:
receiving the second message sent by the second node based on the information indicating the QMC request, wherein the second message comprises capability information related to application layer measurement of the UE,
wherein determining, based on the second message, whether to perform the QMC configuration for the UE comprises:
determining, based on the capability information related to the application layer measurement of the UE, whether to perform the QMC configuration for the UE.

3. The method according to claim 1, wherein the QMC-related request information comprises a requested service type, and receiving the second message sent by the second node in response to the first message comprises:
receiving the second message sent by the second node based on capability of the UE and the requested service type, wherein the second message comprises QMC support indication information of the UE,
wherein determining, based on the second message, whether to perform the QMC configuration for the UE comprises:
determining, based on the QMC support indication information of the UE, whether to perform the QMC configuration for the UE, and
wherein the QMC-related request information further comprises at least one of:
information indicating a QMC request; or
a requested communication type.

4. (canceled)

5. The method according to claim 1, wherein the QMC-related request information comprises the QMC configuration, and receiving the second message which is sent by the second node in response to the first message comprises:
receiving the second message sent by the second node based on capability of the UE and the QMC configuration, wherein the second message comprises an encapsulated RRC release message, and the encapsulated RRC release message contains the QMC configuration,
wherein the method further comprises:
forwarding an RRC release message to the UE, and
wherein the second message further comprises an indication message that determines to perform the QMC configuration.

6. (canceled)

7. The method according to claim 1, wherein determining whether to perform the QMC configuration for the UE comprises at least one of:
sending a third message to the second node in a case of determining to perform the QMC configuration for the UE, wherein the third message comprises the QMC configuration;
receiving a fourth message sent by the second node, wherein the fourth message comprises an encapsulated RRC release message, and an RRC release message comprises the QMC configuration; and sending the RRC release message to the UE; or
sending the QMC configuration to the UE in a case of determining to perform the QMC configuration for the UE; and sending a third message to the second node, wherein the third message comprises a configured QMC.

8. (canceled)

9. The method according to any one of claim 1, wherein sending the first message to the second node comprises:
receiving a request message sent by the UE based on state information of the UE; and
sending the first message to the second node based on the request message.

10. The method according to claim 9, wherein the request message comprises at least one of:
an RRC resume request (RRC Resume Request) message, wherein a resume cause in the RRC Resume Request message is QMC-related information; or
an RRC setup request (RRC Setup Request) message, wherein a cause in the RRC Setup Request message is the QMC-related information,
wherein before receiving the request message sent by the UE based on the state information of the UE, the method further comprises:
sending a paging message to the UE, wherein the paging message comprises QMC-related indication information.

11. (canceled)

12. The method according to any one of claim 1, wherein:
both the first node and the second node are base stations; or,
the first node is a base station, and the second node is a core network node.

13. A method for QMC configuration, executed by a second node and comprising:
receiving a first message sent by a first node, wherein the first message comprises QMC-related request information; and
sending a second message to the first node in response to the first message, wherein the second message is used to determine whether to perform the QMC configuration for a user equipment (UE), wherein the UE is in at least one of an RRC_INACTIVE state or an RRC_IDLE state.

14. The method according to claim 13, wherein the QMC-related request information comprises information indicating a QMC request, and sending the second message to the first node in response to the first message comprises:
sending the second message to the first node based on the information indicating the QMC request, wherein the second message comprises capability information related to application layer measurement of the UE, and the capability information related to application layer measurement of the UE is used to determine whether to perform the QMC configuration for the UE.

15. The method according to claim 14, wherein sending the second message to the first node based on the information indicating the QMC request comprises:
sending the second message to the first node based on the information indicating the QMC request and based on determination as to not relocate a context of the UE,
wherein the second message comprises at least one of:
a partial UE context transfer (Partial UE Context Transfer) message;
a UE QMC context transfer (UE QMC Context Transfer) message;
a retrieve UE context failure (Retrieve UE Context Failure) message; or
another Xn Application Protocol (XnAP) message.

16. (canceled)

17. The method according to claim 13, wherein the QMC-related request information comprises a requested service type, and sending the second message to the first node in response to the first message comprises:
sending the second message to the first node based on capability of the UE and the requested service type, wherein the second message comprises QMC support indication information of the UE, and the QMC support indication information is used to determine whether to perform the QMC configuration for the UE,
wherein the QMC-related request information further comprises at least one of:
information indicating a QMC request; or
a requested communication type.

18. (canceled)

19. The method according to claim 13, wherein the QMC-related request information comprises the QMC configuration, and sending the second message to the first node in response to the first message comprises:
determining, based on the capability of the UE and the QMC configuration, to perform the QMC configuration for the UE; and
sending the second message to the first node, wherein the second message comprises an encapsulated RRC release message, and an RRC release message comprises the QMC configuration,
wherein the second message further comprises an indication message that determines to perform the QMC configuration.

20. (canceled)

21. The method according to claim 13, wherein after sending the second message to the first node, the method further comprises:
receiving a third message from the first node, wherein the third message comprises the QMC configuration; and sending a fourth message to the first node, wherein the fourth message comprises an encapsulated RRC release message, and an RRC release message contains the QMC configuration; or
receiving a third message from the first node, wherein the third message comprises a configured QMC.

22. (canceled)

23. The method according to claim 13, wherein:
both the first node and the second node are base stations; or
the first node is a base station, and the second node is a core network node.

24. A method for QMC configuration, executed by a user equipment (UE) and comprising:
receiving a paging message from a first node, wherein the paging message comprises QMC-related indication information; and
sending a request message to the first node in response to the paging message, wherein the request message is determined based on state information of the UE,
wherein the request message comprises at least one of:
an RRC Resume Request message, wherein a resume cause in the RRC Resume Request is QMC-related information; or
an RRC Setup Request message, wherein a cause in the RRC Setup Request is the QMC-related information.

25. (canceled)

26. A first node, comprising:
a processor; and
a memory for storing instructions executable by the processor,
wherein the processor is configured to execute the method of claim 1.

27. A second node, comprising:
a processor; and
a memory for storing instructions executable by the processor,
wherein the processor is configured to execute the method of claim 13.

28. A user equipment (UE), comprising:
a processor; and
a memory for storing instructions executable by the processor,
wherein the processor is configured to execute the method of claim 24.

29-31. (canceled)

32. A system for QMC configuration, comprising:
the first node of claim 1 and a second node, wherein
the first node is configured to send the first message to the second node, wherein the first message contains the QMC-related request information; and
the second node is configured to receive the first message from the first node and for sending the second message to the first node in response to the first message;
wherein the first node is further configured to receive the second message sent by the second node in response to the first message, and determine, based on the second message, whether to perform the QMC configuration for the UE, wherein the UE is in at least one of the RRC_INACTIVE state or the RRC_IDLE state.
